(19) United States
(12) Patent Application Publication
(10) Pub. No.: US 2026/0093670 A1
(43) Pub. Date: Apr. 2, 2026

(54) SYSTEMS AND METHODS FOR TRANSFORMER INTEGRATION INTO DYNAMIC SCHEMA DATABASES

(71) Applicant: MongoDB, Inc., New York, NY (US)

(72) Inventors: Thomas Rueckstiess, South Yarra (AU); Yixuan Huang, St. Leonards (AU)

(73) Assignee: MongoDB, Inc., New York, NY (US)

(21) Appl. No.: 19/347,384

(22) Filed: Oct. 1, 2025

Related U.S. Application Data
(60) Provisional application No. 63/702,474, filed on Oct. 2, 2024.

(51) Int. Cl. G06F 16/21; G06F 40/274; G06F 40/284; G06N 20/00

(52) U.S. Cl. CPC G06F 16/212; G06F 40/274; G06F 40/284; G06N 20/00

(57) ABSTRACT

Provided is a system for processing semi-structured data, comprising a tokenization module configured to convert JSON objects into token sequences by recursively traversing keys and values (e.g., in depth-first order) and generating sequences of key tokens, value tokens, and grammatical tokens, wherein key tokens are distinguished from value tokens through a transformation that wraps original key strings in a special token format. The system includes a positional encoding module configured to generate hierarchical position embeddings using a PDA that maintains a stack reflecting parsing state, wherein the positional encoding module computes position embeddings by summing embeddings of stack symbols present at each sequence position. A transformer architecture comprising multiple layers of self-attention mechanisms is configured to process combined token and position embeddings. A grammar validation module is configured to enforce valid token sequences by suppressing logits corresponding to invalid transitions according to JSON grammar rules encoded in the PDA.

### RELATED APPLICATIONS

This application claims the benefit under 35 U.S.C. § 119(e) of U.S. Provisional Application No. 63/702,474 entitled “SYSTEMS AND METHODS FOR TRANSFORMER INTEGRATION INTO DYNAMIC SCHEMA DATABASES,” filed Oct. 2, 2024, the entire contents of which are incorporated herein by reference by its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever.

### BACKGROUND

Artificial intelligence has shown promise in analysis and understanding conventional databases. For example, integration with structured database systems has been straightforward and the benefits myriad.

### SUMMARY

The inventors have realized that the functionality conventionally used in transformers needs to be specially architected in order to function in dynamic schema environments also referred to as semi-structured data environments. According to one aspect, novel transformer architecture needs to account for inconsistent data structures across a dynamic schema database. For example, source data may not have the same key value pairs, have different positions for the same key value pairs, key value pairs can be missing from document to document, and/or data can have embedded data structures that further vary architecture across source data. These various differences impact tokenization for any subsequent machine learning. Likewise, training and sequencing of tokens and resulting predictions are also impacted.

Various embodiments are described that include a novel approach to tokenizing dynamic schema data, also referred to as semi-structured data, including, for example, data stored as documents (e.g., JSON documents). In some embodiments, the processing of source database data includes tokenization of each key, key value, array, and nested document data and preserving architecture during tokenization. According to one example, the processing maintains document structure by using special positional codes and a state machine to ensure valid sequences. In further embodiments, the approach improves training efficiency by constraining the model to produce only valid outputs. Some implementations include improved tokenization operations, source architecture maintenance, and positional encoding of source information.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein can be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example can be included in at least one example. The appearances of such terms herein are not necessarily all referring to the same example.

According to one aspect, a system for integrating transformer architecture, the system comprising at least one processor operatively connected to a memory, the at least one processor configured to tokenize dynamic schema database data, the tokenization including positioning information associated with the source data, train a transformer model on the tokenized dynamic schema database data and the positioning information as an input, the transformer model configured to generate predictive distributions corresponding to key value pairs and a valid format for dynamic schema database data, output key value pairs associated with the prediction of the valid format. According to one embodiment, the tokenization includes operations to maintain data architecture information (e.g., “[”, “{”,) associated with the source data. According to one embodiment, the tokenization includes operations to preserve key and value information stored in source document without reduction to sub-words. According to one embodiment, at least one processor is configured to instantiate a pre-trained transformer model, the pre-trained transformer model trained on dynamic schema database data and data architecture information, to output a next data element based on an input data element. According to one embodiment, the at least one processor is configured to generate a predictive distribution associated with frequency of occurrence of respective data elements in response to an input of data elements to the pre-trained transformer model, and define an encoding of associated short code words to data elements based on predicted frequency of occurrence. According to one embodiment, the at least one processor is configured to generate a predictive distribution associated with frequency of occurrence of respective output data elements associated with execution of the query in response to an input of data elements taken from a query under execution to the pre-trained transformer model, and define an encoding of associated short code words to data elements based on predicted frequency of occurrence. According to one embodiment, the at least one processor is configured to generate an output of new dynamic schema database data having a valid format and architecture consistent with the source database in response to an input of data elements taken from a source database including dynamic schema database data. According to one embodiment, the at least one processor is configured to generate a cardinality estimate for queries without having to execute the queries on the source dataset in response to an input of data elements including dynamic schema database data. According to one embodiment, the at least one processor is configured to generate predictive documents unconditionally, and evaluate generated probabilities of a next token following a runtime key input. According to one embodiment, the at least one processor is configured to analyze the probabilities that match a predicate input. According to one embodiment, the pre-trained transformer model is configured to generate an output specific to previously generated tokens. According to one aspect, a computer-implemented method for integrating transformer architecture, the method comprises tokenizing, by at least one processor, dynamic schema database data, the tokenization including positioning information associated with the source data, training, by the at least one processor, a transformer model on the tokenized dynamic schema database data and the positioning information as an input, predicting, using the transformer model, distributions corresponding to key value pairs and a valid format for dynamic schema database data, and producing key value pairs associated with the prediction of the valid format. According to one embodiment, tokenizing includes maintaining data architecture information (e.g., “[”, “{”,) associated with the source data. According to one embodiment, tokenizing includes preserving key and value information stored in source document without reduction to sub-words. According to one embodiment, the method comprises instantiating a pre-trained transformer model, the pre-trained transformer model trained on dynamic schema database data and data architecture information, to output a next data element based on an input data element. According to one embodiment, the method comprises generating a predictive distribution associated with frequency of occurrence of respective data elements in response to an input of data elements to the pre-trained transformer model, and defining an encoding of associated short code words to data elements based on predicted frequency of occurrence. According to one embodiment, the method comprises generating a predictive distribution associated with frequency of occurrence of respective output data elements associated with execution of the query in response to an input of data elements taken from a query under execution to the pre-trained transformer model, and defining an encoding of associated short code words to data elements based on predicted frequency of occurrence. According to one embodiment, the method comprises generating an output of new dynamic schema database data having a valid format and architecture consistent with the source database in response to an input of data elements taken from a source database including dynamic schema database data. According to one embodiment, the method comprises generating a cardinality estimate for queries without having to execute the queries on the source dataset in response to an input of data elements including dynamic schema database data. According to one embodiment, the method comprises generating predictive documents unconditionally, and evaluating generated probabilities of a next token following a runtime key input. According to one embodiment, the method comprises analyzing the probabilities that match a predicate input. According to one embodiment, the method comprises generating an output specific to previously generated tokens. According to one aspect, a system comprises at least one processor operatively connected to a memory, the at least one processor when executing configured to instantiate a pre-trained transformer model, the transformer model trained on dynamic schema database data and data architecture information, to output a next data element based on an input data element, and generate an output of new dynamic schema database data having a valid format and architecture consistent with the source database, in response to an input of data elements taken from a source database including dynamic schema database data. According to one embodiment, the at least one processor is configured to constrain predictions based on token masks to generate the valid format and architecture. According to one embodiment, the pre-trained transformer model is configured to generate predictions for complex multi-token values, the multi-token values associated with array and/or nested objects, and respective architecture information. According to one embodiment, the at least one processor is configured to enable prediction on the complex multi-token values based on, at least in part, sampling beyond single token prediction. According to one embodiment, the at least one processor is configured to continue sampling until reaching an end associated with a complex data object. According to one embodiment, the at least one processor is configured to ensure grammatical validity during both training and inference. According to one embodiment, the at least one processor is configured to ensure grammatical validity based, at least in part, on suppression og logits in the model that lead to invalid transitions. According to one embodiment, the at least one processor is configured to ensure grammatical validity during inference based, at least in part, on ensuring generated sequences maintain structural consistency and enable deserialization into valid data objects, before sampling a next token. According to one embodiment, the at least one processor instantiates a pushdown automaton (“PDA”) to manage constraint enforcement. According to one embodiment, the at least one processor configured to tokenize dynamic schema database data, the tokenization including positioning information associated with the source data, train a transformer model on the tokenized dynamic schema database data and the positioning information as an input for use as the pre-trained transformer model. According to one embodiment, the at least one processor is configured to instantiate the pre-trained transformer model configured to generate predictive distributions corresponding to key value pairs and a valid format for dynamic schema database data in response to input of the data elements taken from the source database including dynamic schema database data. According to one embodiment, the at least one processor is configured to output key value pairs organized as documents data units; and validate consistency in formatting between existing data and newly generated data. According to one embodiment, the tokenization includes operations to maintain data architecture information (e.g., “[”, “{”,) associated with the source data. According to one embodiment, the tokenization includes operations to preserve key and value information stored in source document without reduction to sub-words. According to one embodiment, at least one processor is configured to instantiate a pre-trained transformer model, the pre-trained transformer model trained on dynamic schema database data and data architecture information, to output a next data element based on an input data element. According to one aspect, a computer-implemented method for transformer integration, the method comprises instantiate, by at least one processor, a pre-trained transformer model, the transformer model trained on dynamic schema database data and data architecture information, to output a next data element based on an input data element, and generating, by the at least one processor, an output of new dynamic schema database data having a valid format and architecture consistent with the source database, in response to an input of data elements taken from a source database including dynamic schema database data. According to one embodiment, the method comprises constraining predictions based on token masks to generate the valid format and architecture. According to one embodiment, the method comprise generating predictions for complex multi-token values, wherein the multi-token values are associated with array and/or nested objects, and respective architecture information. According to one embodiment, the method comprises enabling prediction on the complex multi-token values based on, at least in part, sampling beyond single token prediction. According to one embodiment, the method comprises sampling until reaching an end associated with a complex data object.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component can be labeled in every figure. In the figures:

FIG. 1 shows an example block diagram of a system, according to one embodiment;

FIG. 2 is an example computer system that is improved by implementation of the functions, algorithms, and/or processes disclosed herein;

FIG. 3 shows example object data tokenized, according to one embodiment;

FIG. 4 shows example prediction, according to one embodiment;

FIG. 5 illustrates a probability distribution, according to one embodiment;

FIG. 6 illustrates an example tokenization of document data, according to one embodiment;

FIG. 7 illustrates a code assignment example, according to one embodiment;

FIG. 8 is an example transition diagram of an example PDA, according to one embodiment;

FIG. 9A illustrates a tokenization process for transforming JSON data into integer sequences;

FIG. 9B depicts a model architecture with pushdown automaton and transformer components, according to one embodiment;

FIG. 10 shows a pushdown automaton state transition diagram for token processing, according to one embodiment;

FIG. 11 illustrates a sequence diagram showing stack state evolution during token parsing, according to one embodiment;

FIG. 12 depicts training and testing metrics with varying data upscaling factors, according to one embodiment;

FIG. 13 shows a synthetic dataset structure for an example (“dungeons”) validation task, according to one embodiment;

FIG. 14 illustrates a comparison of different positional encoding strategies on model performance, according to one embodiment;

FIG. 15 depicts a performance comparison between the disclosed model and baseline classifiers, according to one embodiment; and

FIG. 16 shows test accuracy results comparing training with and without guardrails mechanism, according to one embodiment.

### DETAILED DESCRIPTION

According to one aspect, systems and methods for integrating transformer models trained on dynamic schema database data are provided. Various embodiments are configured to account for inconsistent data structures across a dynamic schema database. According to one example, keys and values are tokenized without reduction to sub-word or sub-tokens. According to another example, positional information can be included in the token sequence. Maintaining positional information enables regeneration and predictions that return valid document output, among other options. The approach can include code word compression based on prediction of the most frequent token/source information, improving conventional implementation by, among other examples, reducing storage size and/or improving compaction of data.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein is for the purpose of description and should not be regarded as limiting. Any references to examples, embodiments, components, elements, or acts of the systems and methods herein referred to in the singular can also embrace embodiments including a plurality, and any references in plural to any embodiment, component, element, or act herein can also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms.

Although transformers have revolutionized the field of artificial intelligence, their application in the context of dynamic schema database data has proven challenging. Conventional language models are built on a transformer architecture that has been successfully applied to almost every domain and input modality. However, the inventors have realized that dynamic schema data (e.g., document-based data) poses unique challenges in training and predictions. Various problems in dynamic schema data are addressed by embodiments discussed in greater detail below.

Conventional transformers are general sequence-to-sequence learning algorithms. To use transformers for anything that is not naturally a sequence of discrete tokens already, the input data is encoded sequentially. To apply transformers to dynamic schema data (including, for example, documents), various tokenization strategies can be implemented by embodiments disclosed herein. According to one embodiment, the transformer works well (e.g., high accuracy and in other examples reduced training time) with a key/value+grammatical tokens scheme. According to one example, the key/token and grammatical token approach is specially configured to maintain the potentially nested structure of dynamic schema data (e.g., document-based data). Unlike with language models, the system is configured to keep the keys and values as individual tokens. In conventional approaches, tokenization would split keys and values into sub-words. Various embodiments are configured to avoid splitting keys and values into sub-words.

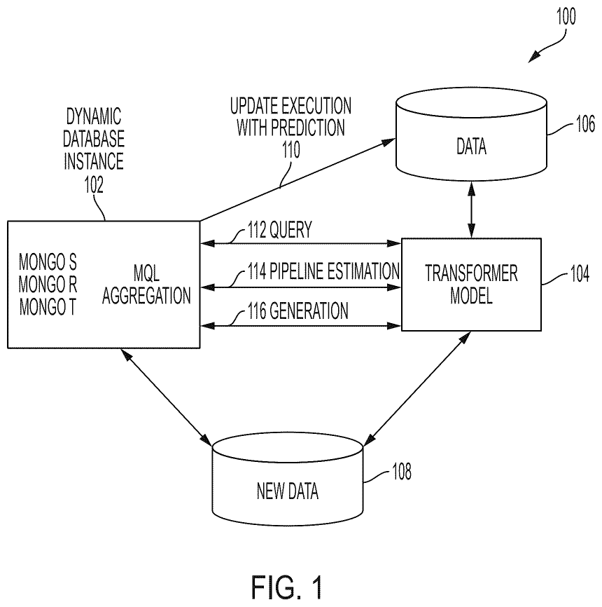

FIG. 1 is a block diagram of an example system 100. The system 100 is configured to manage a dynamic database instance 102 that includes dynamic schema data, which can also be referred to as semi-structured data. In one example, the database is implemented as a well-known MONDODB data/base instance that provides native functionality of that database. The database is improved via integration of transformer functionality that can be used to provide improvements across available functionality (e.g., 110 data write operations, date read operations, query execution 112, pipeline estimation operations 114, data generation 116, etc.). The integration can include one or more or a plurality of transformer models (e.g., 104) trained on semi-structured data (e.g., stored at 106). The transformer can also create new data (e.g., 108) to facilitate any of the operations discussed.

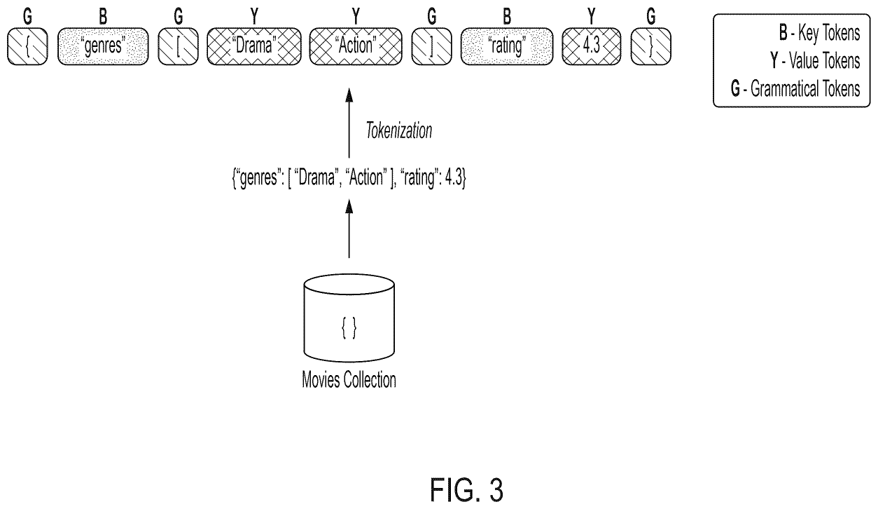

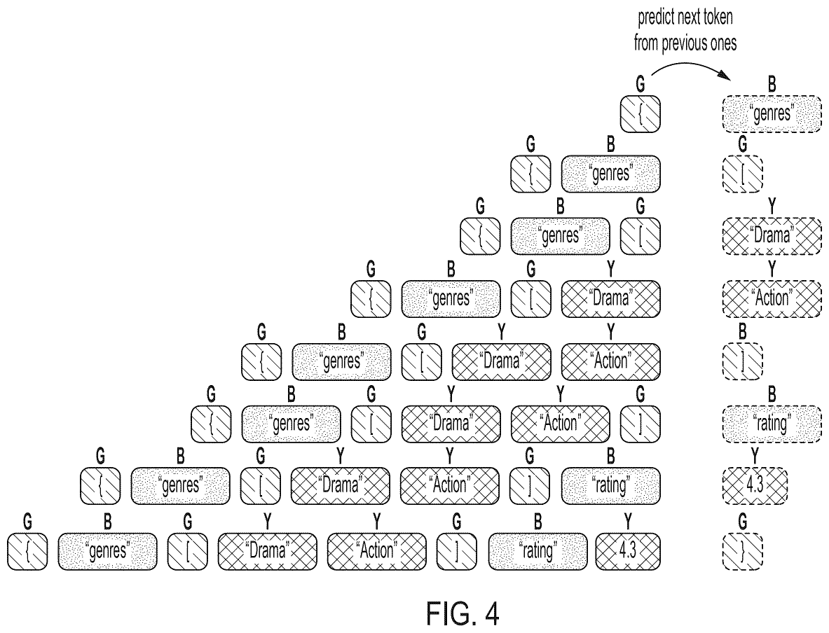

FIG. 3 illustrates an example of tokenization from a “movies” collection (e.g., a collection is a logical named organization of document data). Document data is illustrated as shown as tokenized, and grouped into key tokens “B,” value tokens “Y,” grammatical tokens “G.” The designation in the following figures references the same legend. Once a sequence is generated from the source, the model is trained to predict the next token while considering previous tokens, as shown in FIG. 4 (using the same key legend in the following description). Various implementations are architected similarly to the way a generative pre-trained transformer (“GPT”) language model is trained, with the changes in implementation noted with respect to various examples. Various embodiments provide for “autoregressive” or “causal” modeling to configure the model to look backwards to predict forward.

After training a transformer model (e.g., “DocFormer”) on a collection of documents, the system enables various functionality via prompt. In response, the model can generate different outputs based on the use case described below.

### Example Use Case: Data Generation/Prediction

Various embodiments can be conceptualized like language models and have similar functionality (e.g., with specially configured implementation). For example, DocFormer can be executed to generate a sequence of tokens. By prompting the model with just the start symbol “{” the model can generate/output synthetic documents that have the same distribution as the original collection that was provided in training. According to one embodiment, the generated documents are returned so that they conform to document-based architecture—in other words to that the output is realistic-looking, and consistent with dynamic schema data (e.g., document-based data). In further examples, the model can accept a prompt of a specific prefix of tokens, e.g., {“genres” [“Horror” ]“rating” and the model is configured to auto-complete/output from those inputs or prompts. This is analogous to predicting the most likely rating for Horror movies, i.e., a classification (or in the case of a numeric next token, a regression) task.

### Example Use Case: Estimation

According to some embodiments, the model is configured to represent each next token as a probability distribution—and various examples can leverage access to the distributions. For example, the system can use these probabilities for calculations. In one example, for a given query {rating: {$gt: 3.511, the system can use the probability distribution of the rating value to provide an estimate of how likely it is to find a rating>3.5. This allows the system to estimate cardinalities of queries without executing them, which is important for query planning in a DBMS. Additional embodiments are described here with respective functionality that can be implemented. Other embodiments can incorporate the disclosed functions in various combinations, among other options.

The description of various examples describes a number of changes to conventional approaches that enable transformer architecture to function in the context of dynamic schema data. Various embodiments can incorporate any one or more or any combination of those changes. For example:
LLMs can hallucinate/make syntax errors: {foo: [“bar”,} is not a parseable document. Embodiments of DocFormer include a guardrails system that forces it to only produce valid documents;
DocFormer is trained on the data in a collection, and learns the distribution of that particular dataset. This is useful for a number of tasks, as described below;
DocFormer models are much smaller (megabytes) and can be trained and run locally and in much shorter time improving over conventional architecture/implementation; and
DocFormer can be queried with MQL/aggregation pipelines and return estimates of the results, including counts on queries, which makes it a cardinality estimator among other things.

Various embodiments are described to provide examples of applications, implementation, and/or functionality of the DocFormer model.

### Example Application: Prediction Engine

In some embodiments, once trained on the documents in a MongoDB collection (meaning the model has learned the distribution of the dataset), the DocFormer can be used to predict any target variable based on any input variable(s). Various embodiments can integrate the prediction output as a new execution stage during query processing. For example, aggregation operation/execution can be updated to include a new aggregation pipeline stage $predict that provides command line functions for typical supervised classification/regression tasks.

In various embodiments, the value can be leveraged from the fact that the system can train one single DocFormer model ahead of time, and does not need to train additional models for a given prediction task (usually, or in conventional approaches, this requires one dedicated model per input/target set of fields). In other examples, the system architecture eliminates the need for the user to deal with (manual) feature design. The DocFormer model learns the internal representations of the data source (e.g., learned by the many layers of the deep neural network) and makes manual feature extraction unnecessary. In various examples, even low order accuracy predictions have the ability to improve operation of the database, and in further example, reduce the complexity of developing architecture or understanding of features on users in data sources that routinely vary.

### Code Execution Example 1: Predicting Missing IMDB Ratings of Movies Based on all Other Variables and Writing the Results Back to the Collection

```
JavaScript
> db.movies.aggregate([
  {$match: {imdb: {$exists: false}}}, // find all documents that don't have a
IMDB rating yet
  {$predict: {inputs: “$$ROOT”, target: “imdb”}} // predict IMDB ratings
based on all other fields ($$ROOT)
  {$merge: {...}} // merge results back into collection
```

### Code Execution Example 2: Predicting the Genres of Movies (an Array!) Based on the Director; Runtime and Country of Origin of the Movie, but Keep Existing Genres, and Continue Aggregating ($unwind, $group)

```
JavaScript
> db.movies.aggregate([
  {$predict: {
    inputs: {“director”: “$director”, “runtime”: “$runtime”, “country”: “$country”},
    target: “genres”}, whenMatched: “keepExisting”} // similar to $merge
“whenMatched” semantics
  {$unwind: “$genres”} // unwind the just predicted field
  {$group: {_id: “$genres”, count: {$sum: 1}} // count by (predicted and
pre-filled) genres
])
```

According to various embodiments, transformer implementation can be coupled with the already existing aggregation stages of the well-known MONGODB database $documents stage. In one example, output/predictions can be made on new data not yet stored in the collection.

### Execution Example 3: Predicting the Genres of Movies for New Data and Writing the Results into a New Collection

```
JavaScript
> db.movies.aggregate([
  {$documents: [
    // new movie documents without genres classification
    {title: ‘Son of Batman’, runtime: 74, rated: ‘PG-13’, languages: [“English”], year:
2014, ...},
    // ...
  ]},
  {$predict: {inputs: “$$ROOT”, target: “genres”}, whenMatched: “replace”}}
```

According to one embodiment, the system can be configured to produce the most likely output but also, in conjunction, or instead, return the probabilities of the results. Return of probability distributions is also supported in the DocFormer model, and can be controlled, for example, by command line parameters or query specification. In one example, a parameter returnProbs in the predict method options could be implemented to implement this functionality. In addition to predicting the specified target field, the model would also provide the probabilities of other options for this field.

### Execution Example 4: Predicting Movie Ratings with their Probabilities for Kids Movies from the US

```
  JavaScript
  > db.movies.aggregate([
    {$match: {countries: “USA”, genres: “Kids”}},
    {$predict: {inputs: “$$ROOT”, target: “rated”, returnProbs: “_probs”}}
  ])
  ---
{..., rated: “PG”, _probs: {“PG”: 0.354, null: 0.301, “G”: 0.17, “APPROVED”: 0.085, “PG-13”:
0.042, ...}}
```

Various embodiments are configured to generate and expose other parameters common in language models, such as sampling temperature and top-p (nucleus) sampling. Since the $predict operator is executed as part of the aggregation framework, MongoDB Atlas (and potentially on-prem) clusters (after opt-in), for example, can be tailored to automatically train additional models (e.g., an order agnostic model) to be used alongside each collection. The $predict operator is then made available across native database tools. In various implementations using a dynamic schema database as an example, the additional models can be used to visualize forecasts and predictions, or where users have instant access to a prediction model based on the data stored in their cluster.

### Example Application: Cardinality Estimation

Another application of the DocFormer model includes the ability to estimate counts of queries (e.g., database queries, MongoDB queries, etc.) without having to execute the queries on the dataset. According to various embodiments, Cardinality Estimation (CE) is useful in query planning in DBMS. According to one example, the system is configured to estimate cardinalities on arrays with the DocFormer model, which has proven to be a difficult problem with conventional histogram estimators.

### Execution Example 5: Estimating the Cardinality of the Query [Runtime: [$lt: 60]}

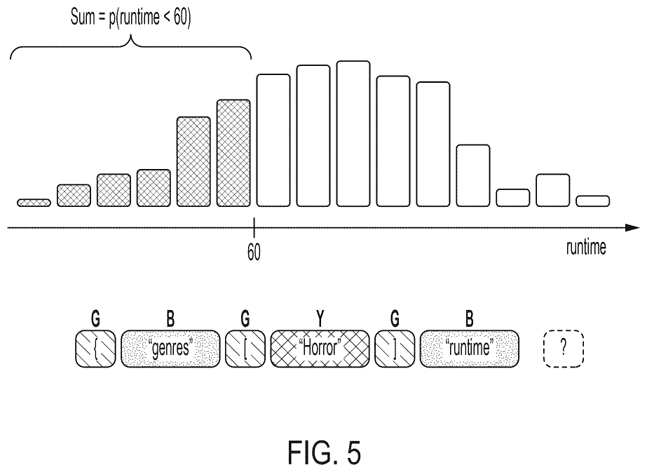

According to one embodiment, to estimate the probability of the above query, the system generates documents unconditionally and leverages the probabilities of the next token following the “runtime” key. In one example, the system is configured to an add up the probabilities that match the predicate (e.g., as shown in FIG. 5). However, the distribution here is specific to the previously generated tokens, i.e., a movie with genres “Horror” in this case. Further examples are configured to get unbiased estimates across all genres (and other preceding fields)—with, for example, functionality to create many different samples at once and average over them. Other options include skipping wildcard fields or implementing order-agnostic modeling.

Apart from query optimization, cardinality estimation (“CE”) can be leveraged by the system in other applications. For example, the system can build recommendations of the best indexes for a given workload. In various embodiments, the system is configured to use such recommended indexes from the model, which often show significant improvements on the performance of a query workload over the indexes recommended by conventional implementation, including native functions of MongoDB (e.g., Atlas Performance Advisor). In one example, the model is a neural network that is trained via multiple iterations over the dataset until the network converges and the error rate is no longer reduced significantly in additional training. Other embodiments include neural networks trained via a single pass over the dataset.

Various embodiment extend estimates past counts as well. For example, using a combination of the prediction and estimation capabilities of the DocFormer, the system can estimate sums, averages, variances etc., and do so on subsets of the data ($match) across multiple groups ($group). In essence, the system can give fast approximate results on aggregations of the form [{$match}, {$group}, {$project}], which cover the majority of aggregations for data exploration and visualization tasks.

Other use cases include ML techniques that train a GPT-style neural network on a next-token prediction objective. Unlike conventional implementation the language is not a natural language but instead a tokenized sequence of a document, which can support nested structures like subdocuments and arrays, as well as type polymorphism and missing values.

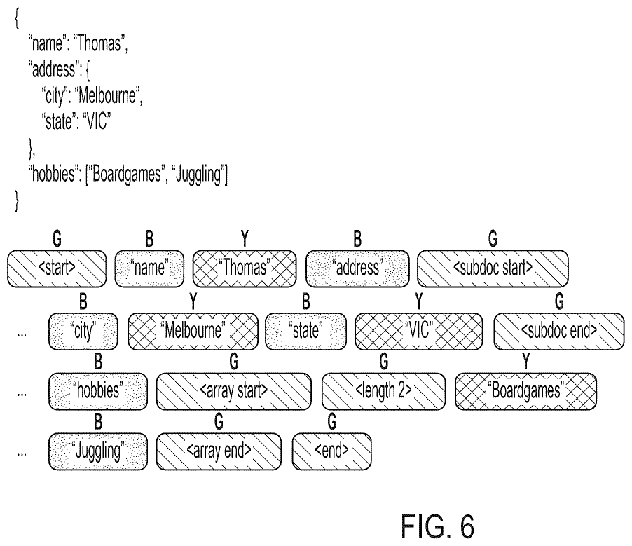

FIG. 6 illustrates an example tokenization of documents, using field (blue “B”), value (orange “Y”) and syntax (green—“G”) tokens. Each document becomes a sequence of tokens and the system employs transformer models for next-token prediction tasks.

### Example Application: Compression

In further embodiments, the system can incorporate the transformer model into lossless compression of documents. For example, using a DocFormer model and Shannon coding, the system can improve compression and data storage over conventional approaches. The system can use the learned probabilities of the DocFormer to generate optimal code words, where the values with the highest probability receive the shortest codes. For example, this implementation leads to highly efficient compression and is beneficial anywhere where the system stores or transmits data (e.g., various native functions, including for backups, initial sync, replication via oplog, chunk migrations, cluster-to-cluster sync, etc., which translates to storage cost savings and faster data transfer).

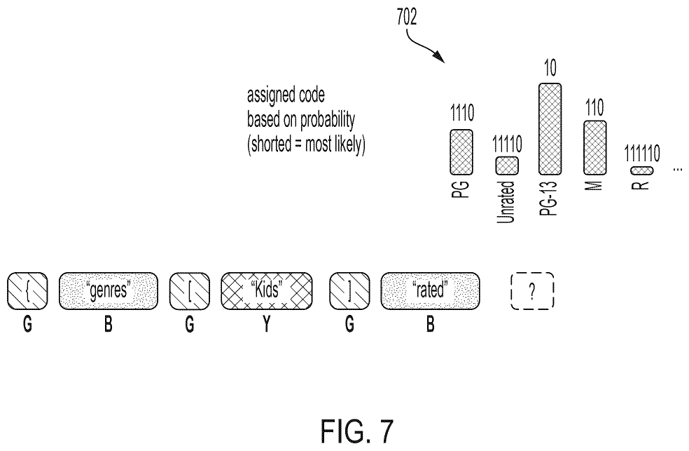

### Execution Example Shown in FIG. 7: Compressing a Document Based on the Probabilities of a Trained DocFormer

In the example shown in FIG. 7, the system is configured to encode the value “PG-13” with only 2 bits (10) (at 702), because it is the most expected next value. Proceeding in this way, the system encodes each value based on the model's learned distribution. The closer the actual data is to the model's learned distribution, the shorter the resulting encoding. To decompress, the system can reverse the process and look up the codes as predicted by the DocFormer at each step, turning them back into values.

### Example Architecture: Decoder-Only Architecture

The original Transformer paper “Attention is all you need” describes an encoder/decoder architecture for the purposes of language translation, where the encoder reads a sequence of tokens from the source language, and the decoder reads a sequence of tokens from the target language, with cross-attention to the source tokens.

### Example Tokenization Operation

Conventional Large Language Models process text into a sequence of tokens. They commonly use techniques such as Byte-pair encoding (BPE) to find common sub-words in text which they group into tokens. In various embodiments discussed herein, the approach is fundamentally different: the system is configured to tokenize the documents based on their keys and values. In a first step, the system is configured to parse the schema of documents in a collection, and record field paths (e.g. “address.city” for a nested sub-document) and their respective values.

For example, the system then creates tokens for each field path identified in the schema, and for each value. For field paths, the system is configured to create special FieldToken tokens, e.g., FieldToken(“address.city”), to distinguish them from equivalent string values, e.g. “address.city”. The system is configured to maintain the type of values: for example, the integer number 42 is treated as a different token than the string “42”.

Additionally, embodiments are configured to include a predefined set of special Symbols in the token vocabulary. These symbols are:
PAD
START
END
FIELD
VALUE
DOC
SUBDOC_START
SUBDOC_END
   Still further embodiments encode arrays with special tokens which include the length of the array, i.e. ArrayStart(5) for the beginning of an array of length 5. These tokens form the vocabulary that the model has access to. Any document from the parsed collection can now be expressed as a sequence of tokens, for example, the document
{“title”: “The Godfather”, “genres”: [“Crime”, “Drama” ], “awards”: {“wins”: 33}} would be converted in the following sequence of tokens:

```
Unset
START FieldToken(“title”) “The Godfather” “FieldToken(“genres”)
ArrayStart(2) “Crime” “Drama” FieldToken(“awards”)
  SUBDOC_START FieldToken(“awards.wins”) 33
  SUBDOC_END END
```

Various embodiments are configured to apply the process discussed above to documents in the dataset. Once completed, the system can be configured to pad each of the sequences with the PAD token up to the length of the longest sequence, to make them all the same length. The token sequences are then converted into sequences of integer numbers, where each token has its unique integer ID.

### Example Embedding

Transformers take the integer sequences as inputs and embed them into a high-dimensional vector space via an embedding matrix before further processing them. The values of the embedding matrix are typically treated as additional parameters to the neural network and can be updated during training, allowing the model to move the token embeddings around in embedding space.

Example Positional Encoding with PDA

Conventional transformers use an attention mechanism that allows them to learn which tokens in the sequence are most relevant to predict the next token. This attention mechanism sees the contextual tokens as an unordered set; it does not consider the order of tokens. Various embodiments are configured to provide the model with information about the order of tokens. Example implementation includes simple positional encoding that takes a sequence of increasing integer values (0, 1, 2, 3 . . . ) up to the sequence length, embeds these integers and adds the embeddings to the token embeddings. This provides the transformer with order information.

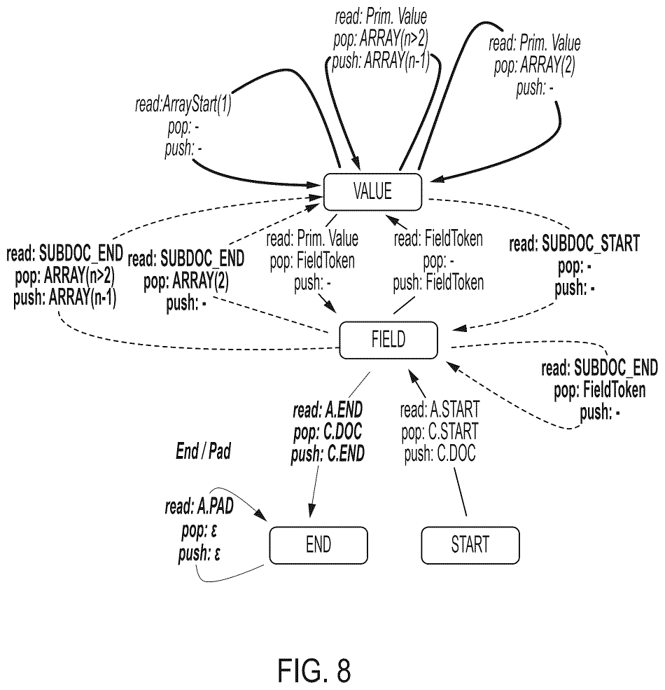

Other embodiments implement a novel positional encoding scheme—for example one which is custom-made for Documents and other JSON-like semi-structured data. The system adapts a concept from formal language theory, namely a deterministic pushdown automaton (or PDA), which consists of different states, a description of state transitions, and a stack onto which it can push or pop symbols. PDAs are automatons that can parse context free grammars, such as JSON. As the PDA reads inputs (namely the token sequences), the system can (optionally) pop a symbol from the stack, (optionally) push a symbol onto the stack, and (optionally) transition into a new state. Each state transition is therefore described as a tuple (input, start_state, end_state, pop_symbol, push_symbol). FIG. 8 is a transition diagram of an example PDA implementation able to process the token sequences described above.

As the system processes a token sequence with the PDA (e.g., show in FIG. 8), the symbols on the stack provide a representation of the position in the document of the current token. The system can use the stack configuration as positional encoding for our sequences as follows: take all the symbols on the stack (which are part of the transformer vocabulary) and embed each of them individually, using the same embedding matrix as the token embeddings. The resulting vectors are then summed up to form the position vector for the current token. This position vector is then added to the token embedding.

### Example Token Shuffling

In a standard transformer architecture for language modeling, the order of tokens is determined by the sentence structure and the positional encoding. The key/value pairs in a dynamic schema source (e.g., a MongoDB document (and in JSON in general)) are considered order-agnostic, however. The following example documents represent the same data and are considered equivalent:
Unset
{“title”: “The Godfather”, “genres”: [“Crime”, “Drama” ], “awards”: {“wins”: 33}}
{“awards”: {“wins”: 33}, “title”: “The Godfather”, “genres”: [“Crime”, “Drama” ]}
{“genres”: [“Crime”, “Drama” ], “awards”: {“wins”: 33}, “title”: “The Godfather” }
   Because of the tokenization process, the system ends up with different token sequences for these documents, but in some embodiments, the document positional encoding strategy is already order-agnostic, allowing the system to permute the key/value pairs in the documents before training the model. This has several advantages:
The system can scale up the dataset to larger sizes by including many permutations of a single document. This prevents (or lessens) overfitting of the model on the training data.
The system can use a single trained model to make predictions for any target field (typically a model is trained specifically with a single target field in mind)
The model becomes more resilient to missing values

### Example Considerations and Example Implementation

Semi-structured data formats such as JavaScript Object Notation (JSON) have gained widespread adoption due to their flexibility and expressiveness in representing complex data relationships. Unlike structured tabular data with fixed schemas, semi-structured formats allow for dynamic and nested structures, making them suitable for applications involving REST APIs, document databases, and search engines. However, the schemaless and nested nature of such data formats presents challenges for end-to-end machine learning applications, often requiring lossy preprocessing steps or labor-intensive manual feature engineering. Traditional approaches may involve flattening JSON data into tabular formats, which can result in large and sparse matrices, or manually designing meaningful features from source data, which demands domain expertise and time-consuming effort.

Examples of new transformer integration systems are described with respect to implementation of an Object Representation via Generative Autoregressive Modelling “ORGAMI” system that address these challenges through a transformer-based architecture that directly processes nested key/value pairs while preserving their hierarchical semantics. Other example embodiments are referenced by “DocFormer” examples herein. Various examples are described with respect to JSON formats, but also apply directly to any semi-structured format.

According to one embodiment, provided is a transformer-based architecture that processes nested key/value pairs while preserving their hierarchical semantics, and in one example, does so directly. Technical contributions over conventional implementation include: (1) a structure-preserving tokenizer, (2) a novel key/value positional encoding scheme, and (3) a grammar-constrained training and inference framework that ensures valid outputs and accelerates training convergence (e.g., these elements and contributions can be implemented separately, in any combination, and collectively). These enhancements enable efficient end-to-end modeling of semi-structured data. By reformulating classification as next-token prediction, implementation examples dubbed ORIGAMI (described in greater detail below) naturally handle both single-label and multi-label tasks without architectural modifications. Empirical evaluation across diverse domains demonstrates ORIGAMI's effectiveness: On standard tabular benchmarks converted to JSON, ORIGAMI remains competitive with classical and state-of-the-art approaches. On native JSON datasets, system embodiments outperform baselines on multi-label classification and specialized models such as convolutional and graph neural networks on a code classification task.

According to one embodiment, the system employs generative autoregressive modeling to approximate the joint distribution over token sequences, enabling supervised classification to be reformulated as a next-token prediction task. This generative approach allows the system to handle both single-label and multi-label classification tasks without requiring architectural modifications. The transformer-based architecture can be configured with varying numbers of layers, attention heads, and embedding dimensions to accommodate different data complexities and computational requirements.

The generative modeling approach used in ORIGAMI differs from discriminative models by approximating the joint distribution p(x) in an order-invariant fashion, allowing predictions for any target key of an object with a single trained model. This contrasts with discriminative approaches that may be hard-coded to predict one specific label given others as input. The generative nature enables the system to produce multi-token outputs, allowing for auto-completion of partial documents or prediction of complex multi-token values such as arrays and nested objects. The order-invariant positional encoding allows sampling of different permutations of the factorization, which acts as a regularization mechanism and may help mitigate overfitting in scenarios with limited training data.

The system processes semi-structured data by representing JSON objects as sequences of tokens and can be implemented following natural language processing paradigms. Various approaches involve converting JSON instances into integer sequences through tokenization and integer encoding, where the tokenization scheme treats keys and values as atomic tokens while maintaining structural information through special grammatical tokens. The resulting token sequences serve as inputs to the transformer-based model, which learns to predict subsequent tokens in the sequence. This methodology enables the system to handle variable-length sequences and complex nested structures without requiring manual preprocessing or feature extraction steps that may result in information loss.

Commonly owned U.S. Pat. No. 10,846,305 describes example implementation associated with the well-known MONGODB database, and commonly owned US Pat. Pub. US-2022-0382778-A1, describes example aggregation architecture and functionality. The described example architecture and functionality can be augmented and improved by the integration of transformer architecture, including command-line functions, aggregation stages, etc. As discussed, unlike conventional approaches, the tokenization of dynamic schema database data is implemented differently. Using JSON as an example of data structure, the processing traverses a JSON document, each key becomes its own token, and each value becomes its own token. For special structures in the JSON (e.g., arrays and/or nested documents), if an array is identified (e.g., of multiple values), array tokens are defined (e.g., square brackets encoded as separate tokens). For nested documents, curly braces are used—having this information provides the basis to reverse the tokenization or to turn the sequence back into a properly formatted document. For example, in tokenization processing, once an opening curly brace is identified, the following material is a sub-document. Based on the contents of most documents, the process can anticipate a key next, and even require that an end or closing brace be identified as part of processing.

According to some embodiments, the additional functionality built into the tokenization provides the basis for being able to reverse the process at the end to turn the sequence into properly formatted document data. As shown above, grammar tokens provide structure information that would otherwise not be encoded under various conventional approaches. The inventors have realized that one problem with documents as source data is that the structure cannot be known ahead of time (unlike conventional structured database data), and that every document can actually be different—e.g., one can have five values in the array, the next one has only three, and the next has no array at all. The data source can have missing keys (e.g., different key values), as well as different positional of the same key values. Thus, conventional tokenization cannot be relied on in this context.

According to one embodiment, the sequence of tokens can be processed by a state machine to ensure architecture is preserved and generated outputs are formatted properly. The state machine can process on a token by token basis, and transitions in the graph depend on what the token it just saw. For example, the transitions can depend on the token being processed into value mode or field mode. At each point in the sequence, the process can establish what tokens are valid.

As discussed, processing can include the value mode or field mode, and thus “knows” that at each point in the sequence, what valid next tokens are allowed. And the system can then enforce that the model can only produce sequences that can be turned back into a document afterwards, among other options. In one example, the modeling here can produce any token out of a vocabulary, but many of these sequences are invalid in the sense that they cannot be turned back into the correct document. Stated technically, various examples of the process integrate a pushdown automaton, but often also as a state machine that ensures that the produced tokens are chosen from those that will maintain a valid structure.

According to some embodiments, the system enforces guardrails to ensure proper formatting is preserved. The training approach described ensures that the tokenization and learning of the sequence part is constrained so that the model cannot learn on things that are improper sequences. Various embodiments give the model information on where in the document a token is or was generated from. For example, a key “title” is at the document-level, and then the first value, add this position document information on top of the key genres for comparison, so that the document has titles and awards.

It is realized that positional encoding becomes more challenging and potentially important when dealing with arrays and/or nested data. By maintaining positional information, afterwards, the system can determine at what level the information was encoded and output data with that level of information. The example discussed below illustrates document-level encoding, then into genres, and then the array is processed and includes position for elements of the array (e.g., three out of three, then array position two out of three, and finally, nothing—equivalent to one). The system and model now have the information on position. Thus, the system includes information for complex data structures when it produces these tokens. Using sub-documents as an example, the awards sub document, and then the next key, “.awards.wins”, can be processed and used to produce tokens, and continuing further down until the process gets to Awards nominations. (Shown by example in FIGS. 3-8). The system is configured to tell the model exactly where this document is and if the model needs to be told, where positionally the information is located in that document (e.g., at the document-level, under the awards, under the wins sub key, etc.). During execution of the process, the pushdown automaton gives the system these values. For example, the system is able to embed them and sum them together, which gives the model enough information to then produce a value for that position.

In further examples, tokenization can include tokens for each key and value in a JSON document. Specific data types, including arrays and nested documents, are tokenized with specific architecture preserving information. FIG. 1 includes description of grammatical tokens used to preserve architecture information. Many conventional approaches, including GPTs (Generalized Pre-trained Transformers) break down key-value pairs into sub-tokens and fail to preserve source data architecture. For example, in conventional approaches, tokenization can involves separate tokens for each quotation mark and/or colons, and how frequent tokens like “genres” might be split into “genre” and “s”. Discussed herein is implementation using positional coding to maintain the structure of source data (e.g., documents) during tokenization. Various embodiments improve over known training and prediction approaches (e.g., in accuracy and compute efficiency) by preserving the structure of the source database data.

### Example Architecture Overview

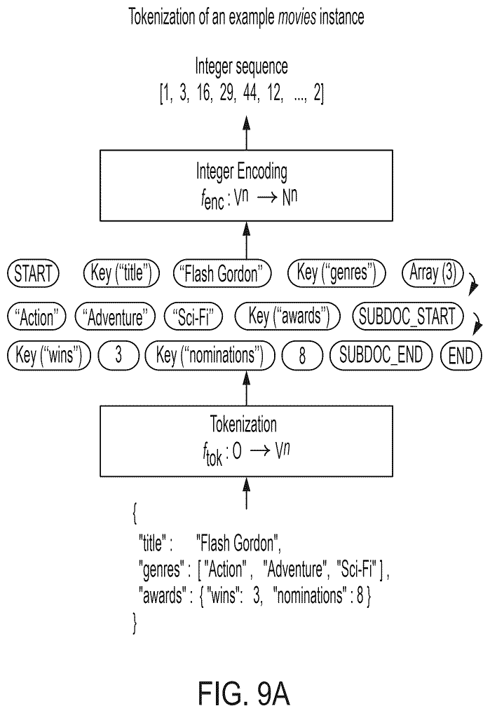

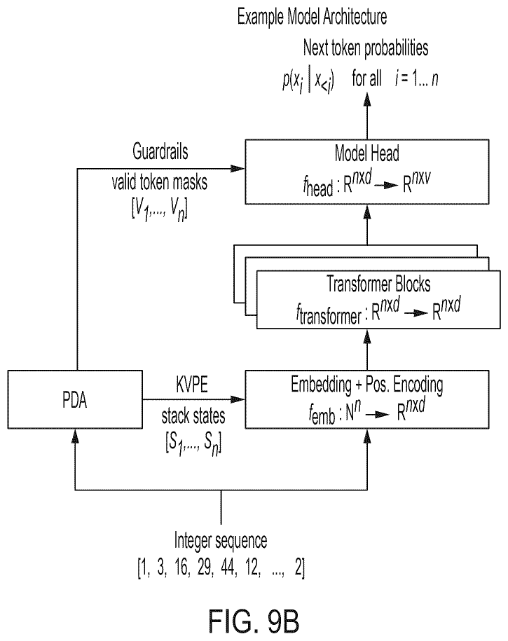

Referring to FIG. 9A and FIG. 9B, an ORIGAMI (Object Representation via Generative Autoregressive Modelling) transformer-based architecture can be configured for end-to-end learning on semi-structured data formats such as JSON. The architecture can process JSON objects directly without requiring conversion to tabular formats or manual feature engineering. In some cases, the system can handle JSON objects with variable schemas where different instances can contain different sets of keys, nested structures of varying depths, and arrays of different lengths. The architecture can maintain the hierarchical semantics of the original data structure throughout the processing pipeline.

As shown in FIG. 9A, the system can include a preprocessing pipeline that transforms JSON objects into integer sequences suitable for transformer processing. The preprocessing can begin with a tokenization function that converts JSON instances into sequences of tokens while preserving structural information. In some cases, the tokenization process can treat keys and values as atomic units and can include special grammatical tokens to maintain the shape of nested objects and arrays. The tokenization can be followed by an integer encoding step that maps each token to a unique numerical identifier, producing sequences that can be processed by neural network components.

With continued reference to FIG. 9A and FIG. 9B, the architecture can operate on deeply nested JSON structures with arbitrary schema variations between instances. The system can handle missing keys that appear in some instances but not others, accommodating the schemaless nature of JSON data. In some cases, the architecture can process variable-length arrays where different instances can contain arrays with different numbers of elements. The system can manage nested objects of varying complexity, from simple key-value pairs to multi-level hierarchical structures containing combinations of objects, arrays, and primitive values.

As illustrated in FIG. 9B, the model architecture can include multiple interconnected components arranged in a processing pipeline. The architecture can receive integer sequences as input and can process these sequences through several transformation stages. In some cases, a pushdown automaton component can generate stack states that capture the hierarchical structure of the input data. The system can include embedding layers that map integer tokens to dense vector representations, and positional encoding components that can incorporate structural information derived from the pushdown automaton states. Multiple transformer blocks can process the embedded representations, and a model head component can generate probability distributions over possible next tokens in the sequence.

The architecture can enable generative modeling of semi-structured data by learning to predict subsequent tokens in a sequence given preceding context. In some cases, the system can reformulate classification tasks as next-token prediction problems where class labels become regular tokens in the model vocabulary. The generative approach can allow the architecture to handle both single-label and multi-label classification tasks without requiring architectural modifications. The system can also support prediction of complex multi-token outputs such as arrays and nested objects by continuing the generation process beyond single token predictions.

### Example Tokenization Process

Referring to FIG. 9A, the tokenization process can convert JSON objects into integer sequences through a transformation pipeline. The tokenization function frok can map each JSON object to a sequence of tokens that preserves the structural and semantic information of the original data. In some cases, the tokenization process can maintain the hierarchical relationships between nested elements while creating a linear representation suitable for sequential processing. The tokenization methodology can handle arbitrary JSON schemas without requiring predefined knowledge of the data structure or field types.

The tokenization function can process primitive values as atomic tokens without subdivision into smaller components. In some cases, string values can be treated as single indivisible tokens rather than being split into sub-word tokens as commonly done in natural language processing applications. The system can handle different types of primitive values including strings, numbers, booleans, and null literals, where each primitive value can become a distinct token in the vocabulary. Boolean values such as true and false can be represented as individual tokens, and null values can be tokenized as null literals. Numeric values can be preserved as complete numerical tokens, maintaining their original precision and format without decomposition into constituent digits or characters.

As shown in FIG. 9A, the tokenization process can incorporate special grammatical tokens to maintain structural information throughout the sequence. The system can include [START] and [END] tokens to demarcate the boundaries of top-level JSON objects, providing clear indicators of document scope. In some cases, nested objects can be represented using [OBJ_START] and [OBJ_END] tokens that preserve the hierarchical structure of embedded objects within the token sequence. Array structures can be tokenized using Array(length) tokens that encode both the presence of an array and its specific length, allowing the system to anticipate the number of subsequent elements without requiring lookahead mechanisms.

The tokenization scheme can include specialized tokens for handling various operational requirements during processing. In some cases, an [UNKNOWN] token can be used to represent values encountered during inference that were not present in the training vocabulary, preventing out-of-vocabulary errors during model deployment. The system can include an [OBJ] token that can serve as a stack symbol in pushdown automaton operations, facilitating the tracking of nested object structures during parsing and generation. Key tokens can be distinguished from value tokens through special Key(s) wrapper notation, where the string s represents the original key name, ensuring that keys and values with identical string content can be differentiated during processing.

With continued reference to FIG. 9A, the system can handle variable-length sequences through a padding mechanism that standardizes sequence lengths for batch processing. The tokenization process can right-pad shorter sequences with [PAD] tokens up to a predefined maximum length, enabling efficient parallel processing of multiple instances with different structural complexities. In some cases, the maximum sequence length can be determined based on the longest sequence in the training dataset, ensuring that no truncation occurs during the tokenization process. The padding approach can maintain the integrity of the original token sequences while providing the uniform dimensionality needed for neural network batch operations.

The encoding function f_{enc} can transform the tokenized sequences into integer representations suitable for neural network processing. As illustrated in FIG. 9A, each unique token in the vocabulary can be assigned a distinct integer identifier through a bijective mapping function. In some cases, the encoding process can create a reversible transformation where integer sequences can be decoded back to their original token representations and subsequently to valid JSON objects. The encoding methodology can preserve the semantic meaning of tokens while converting them to numerical format, maintaining the structural relationships established during the tokenization phase. The combined tokenization and encoding pipeline can produce integer sequences that retain all necessary information for reconstructing the original JSON objects while providing the numerical format needed for transformer-based processing.

### Example Model Architecture Components

Referring to FIG. 9B, the transformer-based model architecture can include multiple interconnected components that process integer sequences through a series of mathematical transformations. The model function f(x; θ) with parameters θ can map an integer sequence x∈ [symbol] ⁿ to a matrix of probabilities Ŷ∈ [symbol] ^{n×v}, where n represents the sequence length and v represents the vocabulary size. In some cases, the model can be decomposed into several functional components including f=f_{head}∘f_{transformer}∘f_{emb}, where each component can perform specific transformations on the input data. The architecture can process batches of sequences in parallel during training and inference, though the batch dimension can be omitted from mathematical notation for clarity. The model can generate probability distributions over the vocabulary for each position in the input sequence, enabling autoregressive generation of token sequences that represent valid JSON structures.

The embedding layer f_{emb} can map tokenized integer sequences into a d-dimensional real-valued embedding space through the transformation f_{emb}: [symbol] ⁿ→ [symbol] ^{n×d}. As shown in FIG. 9B, the embedding layer can contain an embedding matrix E∈ [symbol] ^{v×d} and a token embedding function e: {1, . . . , v}→ [symbol] ^{d} that maps integer i to the i-th row of E with e(i)=E_{i,:}. The embedding layer can sum token embeddings with position embeddings of the same dimensionality, producing the combined representation f_{emb}(x)=[e(x₁)+kvpe(x, 1), e(x₂)+kvpe(x, 2), . . . , e(xₙ)+kvpe(x, n)]^{T}. In some cases, the kvpe(x, i) function can denote the key/value position embedding of integer sequence x at position i, encoding positional and structural information derived from pushdown automaton stack states. The embedding matrix E can be learned during training through backpropagation, allowing the model to develop representations that capture semantic relationships between tokens in the vocabulary.

With continued reference to FIG. 9B, the transformer component f_{transformer}: [symbol] ^{n×d}→ [symbol] ^{n×d} can represent a stack of decoder-only transformer blocks with self-attention mechanisms. Each transformer block can apply multi-head self-attention followed by position-wise feed-forward networks, incorporating residual connections and layer normalization as standard architectural components. The self-attention mechanism can compute attention weights between all pairs of positions in the input sequence, allowing the model to capture long-range dependencies and contextual relationships within the token sequence. In some cases, the decoder-only architecture can use causal masking to prevent attention to future positions, maintaining the autoregressive property needed for sequential generation. The transformer blocks can progressively refine the representations through multiple layers, with each layer building upon the outputs of previous layers to develop increasingly sophisticated feature representations.

The classification head component f_{head}: [symbol] ^{n×d}→ [symbol] ^{n×v} can map the hidden representations from the final transformer block to probability distributions over the vocabulary. As illustrated in FIG. 9B, the model head can receive valid token masks from a guardrails component and can produce next token probabilities as output. Each row vector ŷ=Ŷ_{i,;} can form a proper categorical probability distribution over the vocabulary with constraints 0≤ŷⱼ≤1 and

$${\sum }_{j = 1}^{v} {\hat{y}}_{j} = 1$$

through application of the softmax function on unnormalized logits. The classification head can enable the model to predict the next token in the sequence given all preceding tokens, supporting the autoregressive generation process. In some cases, the head component can incorporate linear projection layers that transform the d-dimensional hidden representations to v-dimensional logit vectors before softmax normalization.

The architecture can support prediction of complex multi-token values such as arrays and nested objects, through continued sampling beyond single token predictions. When the model encounters an Array(n) token during generation, the system can continue to sample the next n tokens to complete the array structure, where n represents the length specified in the Array token. In some cases, the model can predict nested objects by generating sequences of [OBJ_START], key-value pairs, and [OBJ_END] tokens that represent the hierarchical structure of embedded objects. The autoregressive generation process can handle variable-length structures by sampling tokens sequentially until appropriate termination conditions are met, such as encountering [END] tokens for top-level objects or [OBJ_END] tokens for nested structures. The multi-token prediction capability can enable the architecture to generate complete JSON documents with arbitrary complexity, including deeply nested structures containing combinations of objects, arrays, and primitive values. The model can maintain structural consistency throughout the generation process by leveraging the grammatical constraints enforced by the pushdown automaton component, ensuring that generated sequences represent valid JSON objects that can be successfully parsed and deserialized.

### Example Pushdown Automaton for Grammar Enforcement

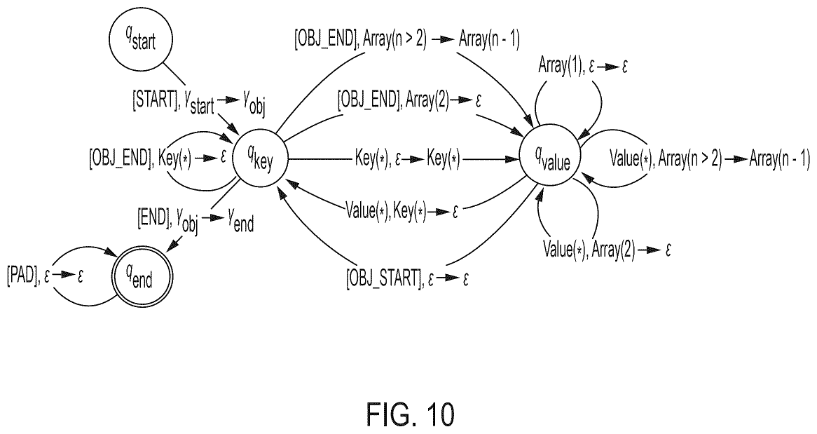

Referring to FIG. 10, a deterministic pushdown automaton (PDA) can be implemented to recognize the context-free language of token sequences generated during the tokenization process. The PDA can serve multiple functions within the architecture, including generation of stack states for positional encoding, acceleration of training convergence through grammatical constraint enforcement, and constrained decoding during inference to ensure valid JSON object generation. In some cases, the PDA can be formally defined as a 6-tuple M=(Q, Σ, F, δ, qₛₜₐᵣₜ, F), where each component can specify the operational parameters and behavioral constraints of the automaton. The PDA can operate on token sequences to maintain structural information and enforce grammatical validity throughout both training and inference phases.

The state set Q can include four distinct states: Q={qₛₜₐᵣₜ, q_{end}, q_{key}, qᵥₐₗᵤₑ}, where each state can represent a specific parsing context within the JSON structure. As shown in FIG. 10, the input alphabet Σ can correspond to the global token vocabulary V, encompassing all possible tokens that can appear in the tokenized sequences. The stack alphabet Γ can include array tokens from V_{array}, key tokens from V_{key}, and specialized stack symbols including γₛₜₐᵣₜ, γ_{obj}, and γ_{end}. In some cases, these stack symbols can be set to specific token values: γₛₜₐᵣₜ:=[START], γ_{obj}:=[OBJ], and γ_{end}:=[END], ensuring that all stack symbols can be part of the vocabulary V and can have corresponding entries in the embedding matrix E. The start state qₛₜₐᵣₜ can initiate the parsing process, while the accepting state set F={q_{end}} can define the conditions for successful sequence completion.

With continued reference to FIG. 10, the transition function δ can define the valid state transitions and stack manipulations that can occur during token sequence processing. The transition diagram can illustrate edges labeled with the format “σ, γₚₒₚ→γₚᵤₛₕ”, where a represents the input token being read, γₚₒₚ represents the stack symbol being removed, and γₚᵤₛₕ represents the stack symbol being added. The PDA can include transitions for Key( ), Value( ), and Array( ) tokens, where these transitions can be instantiated for each specific key token t∈V_{key}, value token t∈Vᵥₐₗᵤₑ, and array token t∈V_{array} in the vocabulary. In some cases, the transition rules can be crafted such that the PDA accepts only token sequences representing valid JSON objects produced by the tokenization function, while rejecting all other sequences that do not conform to proper JSON grammar.

The PDA can maintain stack states that capture the hierarchical structure of JSON objects during sequence processing. For a token sequence t₁, . . . , tₙ and position i=1 . . . n, the stack state sᵢ can be defined as the kᵢ-tuple of stack symbols sᵢ=[γ_{i,1}, . . . , γ_{i,ki}]∈Γ^{k}ᵢ where kᵢ represents the current stack depth. The stack state can reflect the contents of the stack after processing the first i tokens, with the number of stack symbols kᵢ potentially varying for different positions as symbols can be pushed onto or popped from the stack during sequence traversal. In some cases, the stack states can encode the nested key paths and array positions within the JSON structure, providing the structural information needed for positional encoding calculations. The evolution of stack states can follow the hierarchical organization of the JSON data, with keys and array tokens being pushed during depth-first traversal and removed when stepping back up in the object hierarchy.

As illustrated in FIG. 10, the PDA can implement a guardrails mechanism that enforces grammatical validity during both training and inference phases. The system can suppress logits in the model head f_{head} that would lead to invalid transitions by setting the corresponding logit values to negative infinity before applying the softmax function. In some cases, this logit suppression can occur during training before calculating the cross-entropy loss, preventing the model from learning to predict grammatically invalid token sequences. The guardrails mechanism can also operate during inference before sampling the next token, ensuring that generated sequences maintain structural consistency and can be successfully deserialized into valid JSON objects. The PDA-based constraint enforcement can accelerate training convergence by focusing the model's learning capacity on data correlations rather than grammar rules, allowing the architecture to develop more effective representations of the underlying semantic patterns in the training data.

The pushdown automaton can utilize specific stack symbols to maintain structural information throughout the parsing and generation processes. The [START] and [END] tokens can serve as boundary markers for top-level JSON objects, while [OBJ_START] and [OBJ_END] tokens can demarcate nested object structures within the hierarchy. Array tokens can be represented as Array(length) symbols that encode both the presence of an array and its specific length parameter, enabling the PDA to track the expected number of subsequent array elements. In some cases, key tokens can be pushed onto the stack when entering nested structures and can be popped when exiting those structures, maintaining a record of the current key path within the JSON hierarchy. The stack symbol management can ensure that the PDA maintains accurate structural state information that can be utilized for positional encoding calculations and grammatical constraint enforcement throughout the sequence processing pipeline.

### Example Key/Value Positional Encoding (KVPE)

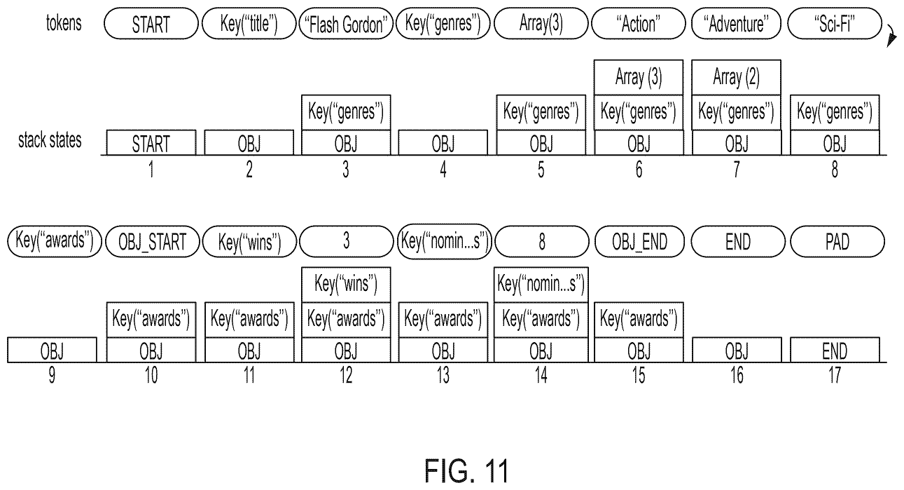

Referring to FIG. 11, the key/value positional encoding (KVPE) method can utilize stack states from the pushdown automaton to generate position embeddings that capture hierarchical relationships within JSON structures. The KVPE approach can address the limitations of traditional positional encoding strategies that can be unsuitable for JSON objects due to the unordered nature of key/value pairs as specified in the JSON specification. In some cases, the absolute position of any particular key/value pair can change from object to object due to preceding missing keys or variable-length arrays, making conventional positional encoding methods inadequate for semi-structured data processing. The KVPE method can provide a solution by encoding the hierarchical key path and array position of each token while maintaining invariance to the order permutation of key/value pairs and their relative positions in the token stream.

As illustrated in FIG. 11, the evolution of stack states during token sequence parsing can demonstrate how the pushdown automaton maintains structural information throughout the processing of a JSON object. The figure can show the progression of stack states from initial parsing through various nested structures, with each state reflecting the hierarchical context of the current token position. The stack states can evolve as the automaton processes tokens in depth-first order, with keys and array tokens being pushed onto the stack during traversal into nested structures and removed when stepping back up in the object hierarchy. In some cases, the stack state at position 7 can show the value “Adventure” belonging under the key “genres” at the second position in an array, with the corresponding stack containing symbols [OBJ], Key(“genres”), and Array(2) that encode the complete hierarchical path to that token position.

The mathematical formulation of KVPE can be defined through the relationship between stack states and position embeddings, where the position information can align with the stack state of the pushdown automaton M. For input sequence x and position i, the KVPE function can be expressed as

$$kvpe ( {x}^{( j )} , i ) = {\sum }_{l = 1}^{{k}_{i}} e ( {f}_{e n c} ( {γ}_{i , l} ) ) ,$$

where kᵢ represents the stack depth at position i, γ_{i,l} denotes the l-th stack symbol at position i, and e represents the token embedding function. The summation can aggregate the embeddings of all stack symbols present at a given position, creating a composite position embedding that encodes the complete hierarchical context. In some cases, the stack symbols can be part of the vocabulary by design, with Γ⊆V, allowing them to be encoded into integers with f_{enc} and subsequently embedded using the same embedding matrix E used for regular tokens.

With continued reference to FIG. 11, the compositional nature of KVPE over nested key paths can enable the encoding method to represent complex hierarchical structures through additive combinations of stack symbol embeddings. The position embedding for any token can be computed as the sum of embeddings corresponding to all stack symbols that define the path from the root object to the current position, including object markers, key identifiers, and array position indicators. The recursive order-invariant property can ensure that key/value pairs at the same hierarchical level contribute equivalent positional information regardless of their sequential ordering within the token stream. In some cases, this order-invariance can enable the sampling of different permutations of the factorization order during training, where the model can learn to predict tokens in various sequences while maintaining consistent positional relationships based on structural hierarchy rather than linear position.

The KVPE method can create unique position embeddings for each logical position in the JSON object hierarchy by leveraging the structural information maintained by the pushdown automaton stack. As shown in FIG. 11, different tokens can receive distinct position embeddings based on their hierarchical context, even when they appear at similar sequential positions in the token stream. The position embedding calculation can incorporate object boundary markers such as [OBJ] tokens that indicate the root object context, key tokens that specify the current attribute being processed, and array tokens that encode both the presence of an array structure and the specific position within that array. In some cases, the additive nature of the embedding summation can allow the positional encoding to capture multiple levels of nesting simultaneously, with each stack symbol contributing its semantic information to the final positional representation.

The order-invariant properties of KVPE can enable flexible factorization of the joint distribution over JSON structures, supporting the training objective of learning permutation-invariant representations of semi-structured data. The positional encoding method can maintain consistent representations for logically equivalent positions across different orderings of key/value pairs, allowing the model to generalize effectively to JSON objects with varying key sequences. The compositional property over nested key paths can ensure that tokens at similar hierarchical depths receive related positional encodings, facilitating the learning of structural patterns that transcend specific token orderings. In some cases, the KVPE approach can support the generation of multiple factorization orders during training, where each permutation of key/value pairs can receive consistent positional treatment based on hierarchical structure rather than sequential arrangement, enabling the model to develop robust representations that capture the semantic relationships inherent in semi-structured data formats.

### Example Factorization Order Permutations and Data Upscaling

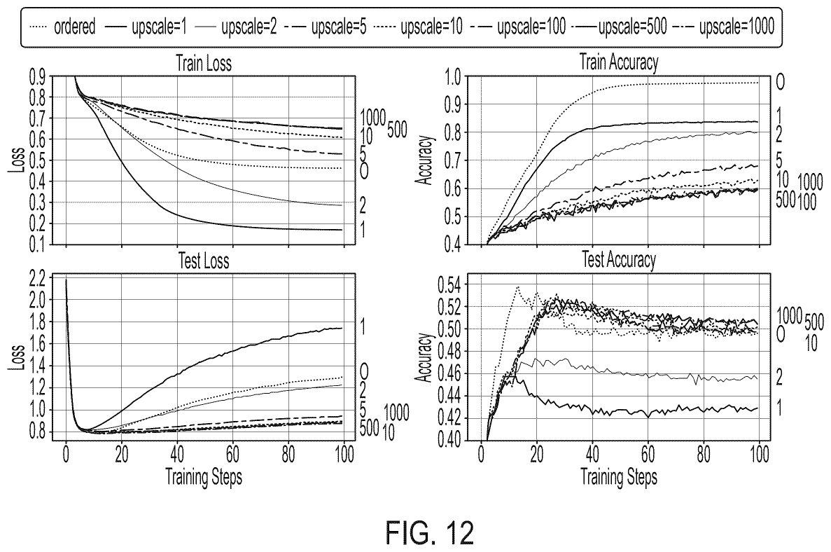

Referring to FIG. 12, the system can implement factorization order permutations and data upscaling mechanisms to enhance model performance and mitigate overfitting in small data regimes. The architecture can sample different permutations of key/value pair orderings during training, leveraging the unordered nature of JSON objects as specified in the JSON specification to create multiple valid representations of each training instance. In some cases, the permutation sampling can act as a regularization technique that prevents the model from learning spurious correlations based on specific token orderings rather than semantic content. The upscaling functionality can generate multiple training instances from each original example by creating different factorization orders of the same underlying JSON structure, effectively augmenting the dataset without requiring additional data collection or manual annotation.

As illustrated in FIG. 12, experimental results can demonstrate the effects of different upscaling factors on model performance across training and test datasets. The figure can show four subplots displaying train loss, train accuracy, test loss, and test accuracy metrics plotted against training steps, with different colored lines representing upscaling factors ranging from 1 to 1000. The results can indicate that low upscaling factors can lead to overfitting behavior on the training data, characterized by decreasing training loss and increasing training accuracy while test loss increases after an initial drop. In some cases, the graphs can demonstrate that upscaling factors beyond 5× can mitigate the overfitting phenomenon, with test accuracy generally improving as the upscaling factor increases. The dotted line representing ordered sequences can provide a baseline comparison, showing the performance when no permutation sampling occurs during training.

With continued reference to FIG. 12, the upscaling methodology can generate multiple permutations of each original training instance by reordering key/value pairs at the same hierarchical level within JSON objects. The system can create different factorization orders while maintaining the structural integrity and semantic content of the original data, ensuring that each permuted instance represents a valid alternative ordering of the same information. In some cases, the upscaling process can sample random permutations of key/value pairs within objects, creating diverse training examples that expose the model to various presentation formats of identical semantic content. The permutation generation can respect the hierarchical structure of nested objects and arrays, applying reordering operations at appropriate levels of the JSON hierarchy without disrupting parent-child relationships or array element sequences.

The regularization effect of permutation sampling can emerge from the model's inability to rely on specific token orderings to make predictions about subsequent tokens in the sequence. As shown in FIG. 12, higher upscaling factors can force the model to learn representations that capture semantic relationships rather than positional dependencies, leading to improved generalization performance on test data. The system can prevent the model from memorizing particular key sequences by presenting the same logical content in multiple orderings, encouraging the development of position-invariant feature representations. In some cases, the regularization mechanism can be particularly effective in small data regimes where traditional overfitting mitigation techniques can be insufficient due to limited training examples. The permutation-based approach can enable the model to extract more robust patterns from limited data by exposing it to a broader range of structural variations during training.

The data augmentation process can multiply the effective size of the training dataset by a factor corresponding to the chosen upscaling parameter, creating additional training instances without requiring new data sources. The upscaling functionality can generate permuted versions of each original training example during the preprocessing phase, storing multiple representations of the same semantic content with different key/value orderings. In some cases, the system can sample permutations dynamically during training, creating fresh orderings for each epoch to maximize the diversity of training examples presented to the model. The augmentation methodology can maintain the original class labels and target values for all permuted instances, ensuring that the expanded dataset preserves the supervised learning objectives while providing increased structural diversity. The upscaling approach can enable effective training on datasets with limited instances by artificially expanding the available training examples through valid structural transformations of the original data.

### Example Synthetic Dataset Validation

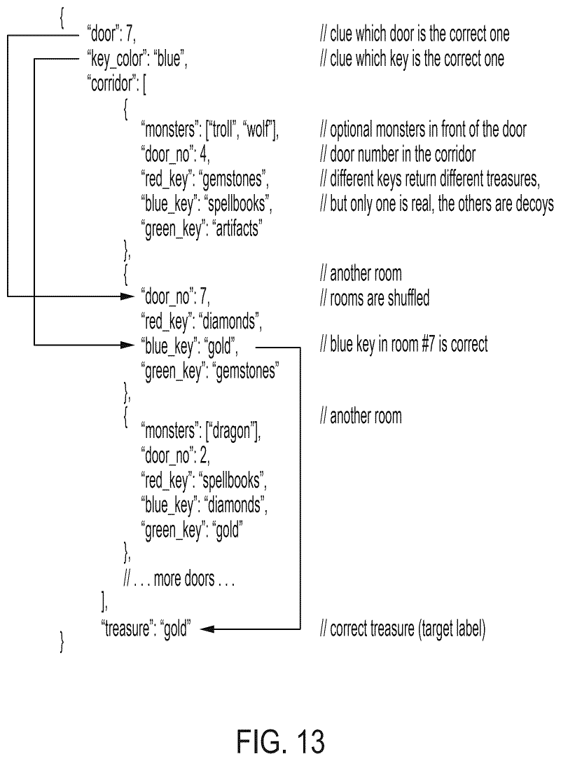

Referring to FIG. 13, a synthetic dataset structure called “Dungeons” can be implemented to test the model's ability to perform logical reasoning over nested JSON structures with complex hierarchical relationships. The dataset can contain a corridor array with between 4 and 8 objects, where each object can include a door_no key and three color-coded keys designated as red_key, green_key, and blue_key. The objects can contain between 0 and 2 monsters that can be randomly selected from a predefined set, adding further randomness to the positions of informative tokens while having no effect on the target prediction task. The synthetic nature of the dataset can enable controlled testing of specific architectural components by isolating particular reasoning challenges that can occur in real-world semi-structured data processing scenarios.

The dataset generation process can incorporate two top-level keys designated as “door” and “key_color” that can provide clues indicating which corridor object contains the correct answer for the target key “treasure.” The system can require logical reasoning to locate the corridor object with the matching door_no value and subsequently retrieve the corresponding treasure based on the key_color specification. As shown in FIG. 13, the dataset can include 5 different treasure types that can be assigned uniformly at random, providing a 20% baseline probability for random guessing performance. The treasure types can include values such as “gemstones,” “spellbooks,” “artifacts,” “gold,” and other fantasy-themed items that can serve as classification targets for the supervised learning task.

With continued reference to FIG. 13, the dataset structure can present specific challenges for validating architectural components through its requirement for multi-step logical reasoning over nested structures. The model can need to parse the top-level “door” value, traverse the corridor array to locate the object with the matching door_no, and then extract the treasure value corresponding to the specified key_color from that particular corridor object. The presence of randomly positioned monsters within corridor objects can introduce additional complexity by creating variable token positions for the informative elements, testing the model's ability to maintain focus on relevant information while ignoring distracting content. The shuffling of corridor objects and keys can further challenge the architecture's capacity to perform position-invariant reasoning over semi-structured data.

The synthetic dataset can enable systematic evaluation of the key/value positional encoding method by requiring the model to maintain accurate hierarchical context throughout the reasoning process. The nested structure can test whether the positional encoding can effectively capture the relationships between top-level clues and deeply embedded target values within array elements. In some cases, the dataset can validate the effectiveness of the pushdown automaton's stack state management by requiring consistent tracking of nested object boundaries and array positions during the logical reasoning sequence. The controlled nature of the synthetic data can allow for precise measurement of how different architectural components contribute to the model's ability to perform structured reasoning tasks.

As illustrated in FIG. 13, the dataset configuration can include parameters for controlling the complexity of the reasoning task, such as the minimum and maximum number of doors, the number of keys per door, the presence or absence of monster arrays, and the shuffling behavior of doors and keys. The generation process can create two variants designated as dungeons-hard and dungeons-easy, where the easier version can maintain unshuffled corridor arrays that place each door object at the position corresponding to its door number. The harder variant can shuffle both corridor objects and keys, requiring the model to perform more sophisticated pattern matching and logical inference without relying on positional cues. The parameterized generation approach can enable systematic testing of model performance across different levels of structural complexity and reasoning difficulty.

The validation methodology using the synthetic dataset can provide insights into the model's capacity to learn rule-based reasoning patterns from limited training examples. The dataset can test whether the architecture can extract the underlying logical relationship between top-level clues and nested target values, rather than memorizing specific token sequences or positional patterns. In some cases, the synthetic validation can reveal the effectiveness of the guardrails mechanism in preventing the model from learning grammatically invalid token sequences while focusing learning capacity on the logical reasoning task. The controlled experimental environment can enable precise attribution of performance improvements to specific architectural innovations, such as the key/value positional encoding method or the factorization order permutation strategy.

### Example Positional Encoding Ablation Study

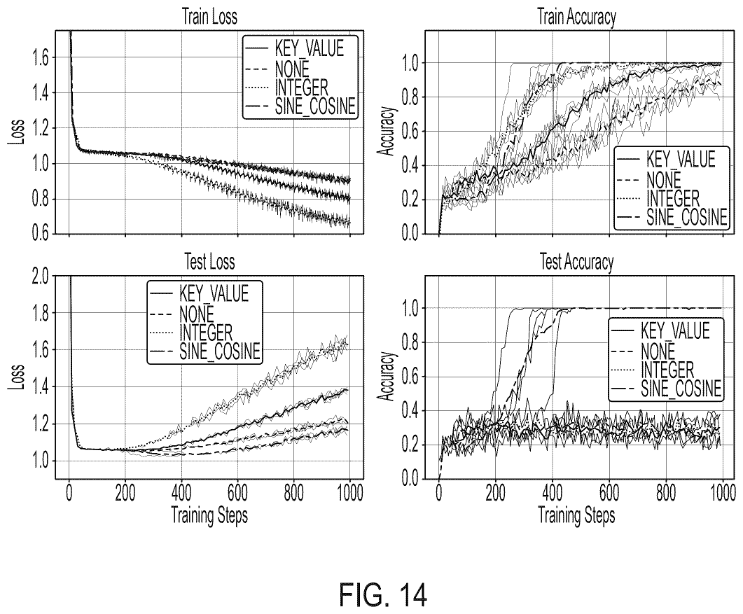

Referring to FIG. 14, a comparative analysis can evaluate different positional encoding strategies to demonstrate the improvement of structure-aware positional encoding for generalization performance on test data. The ablation study can compare four distinct positional encoding methods: the key/value positional encoding (KVPE) approach, absolute integer positional encoding, sinusoidal positional encoding, and a configuration with no positional encoding. The experimental design can utilize the same model architecture and training procedures across all positional encoding variants, isolating the impact of positional information representation on model performance. In some cases, the study can provide empirical evidence for the effectiveness of structure-aware positional encoding in semi-structured data processing tasks where traditional positional encoding methods can be inadequate.

As illustrated in FIG. 14, the comparative results can be presented across four subplots showing train loss, train accuracy, test loss, and test accuracy metrics plotted against training steps. The experimental data can demonstrate distinct performance patterns for each positional encoding strategy, with the KEY_VALUE approach showing superior generalization capabilities compared to alternative methods. The train loss subplot can indicate that all positional encoding strategies achieve decreasing loss values over time, with the INTEGER encoding method showing the lowest final training loss among the alternatives. In some cases, the train accuracy subplot can reveal that both KEY_VALUE and INTEGER encoding strategies achieve rapid convergence to high accuracy levels, while SINE_COSINE and NONE methods can exhibit slower or less stable training progression.

With continued reference to FIG. 14, the test performance metrics can reveal the critical importance of structure-aware positional encoding for generalization to unseen data. The test loss subplot can show increasing loss trajectories for all positional encoding strategies except KEY_VALUE, which can maintain consistently low test loss throughout the training process. The INTEGER, SINE_COSINE, and NONE positional encoding methods can exhibit characteristic overfitting behavior, with test loss increasing after initial decreases despite continued improvements in training metrics. The test accuracy subplot can demonstrate that only the KEY_VALUE positional encoding strategy achieves successful generalization on test data, reaching and maintaining high accuracy levels while alternative methods can remain at substantially lower accuracy plateaus.

The experimental results can highlight the limitations of traditional positional encoding approaches when applied to semi-structured data formats with hierarchical relationships and variable ordering constraints. Absolute integer positional encoding can fail to capture the semantic relationships between tokens that occupy different sequential positions but represent logically equivalent structural roles within JSON objects. Sinusoidal positional encoding, while effective for natural language processing tasks with inherent sequential ordering, can not provide appropriate inductive biases for data formats where positional relationships depend on hierarchical structure rather than linear sequence. In some cases, the absence of positional encoding can eliminate important structural information entirely, preventing the model from learning meaningful relationships between tokens based on their logical positions within the JSON hierarchy.

As shown in FIG. 14, the KEY_VALUE positional encoding method can demonstrate superior performance by incorporating structural information derived from the pushdown automaton stack states, enabling the model to maintain consistent representations for logically equivalent positions across different token orderings. The structure-aware approach can provide position embeddings that reflect the hierarchical relationships within JSON objects, allowing the model to generalize effectively to test instances with different key/value pair orderings or structural variations. The KVPE method can enable the architecture to focus on semantic content and logical relationships rather than spurious correlations based on specific token sequences, leading to robust performance on held-out data. In some cases, the positional encoding strategy can serve as a form of regularization that prevents overfitting by ensuring that positional information remains consistent across different factorization orders of the same underlying JSON structure, supporting the model's ability to learn transferable patterns that generalize beyond the specific orderings encountered during training.

### Model Performance Comparison

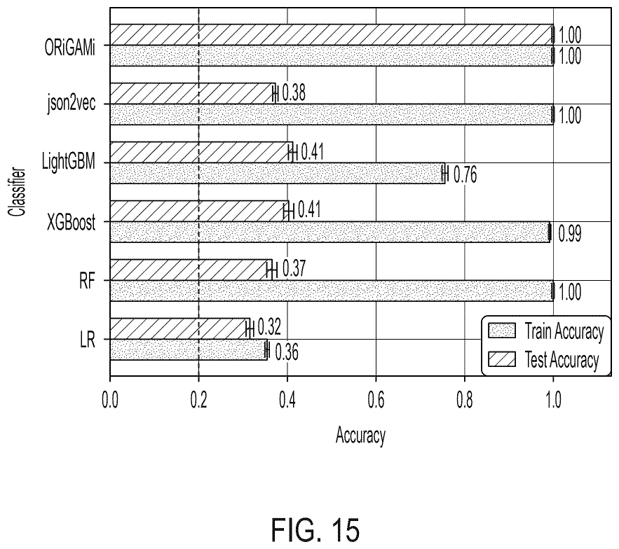

Referring to FIG. 15, the performance comparison results on the dungeons-hard dataset can demonstrate the superior generalization capabilities of the ORIGAMI architecture compared to traditional tabular and JSON processing approaches. The bar chart illustrates accuracy measurements for six different classifiers including ORIGAMI, json2vec, LightGBM, XGBoost, Random Forest (RF), and Logistic Regression (LR), with each classifier displaying both training accuracy and test accuracy metrics. The horizontal axis can represent accuracy values ranging from 0.0 to 1.0, while the vertical axis can list the different classification methods. In some cases, the blue bars represent training accuracy performance while the orange bars indicate test accuracy results, providing a clear visual comparison of each model's ability to generalize from training data to unseen test instances.

As illustrated in FIG. 15, several baseline classifiers can achieve high training accuracy levels approaching or reaching perfect performance on the training dataset. The json2vec, LightGBM, XGBoost, and Random Forest methods can demonstrate training accuracies at or near the 1.0 mark, indicating that these models can successfully memorize the training examples and achieve near-perfect classification performance on the data used for model fitting. The Logistic Regression approach can show somewhat lower training accuracy compared to the other baseline methods, though the training performance can still reach substantial accuracy levels. In some cases, the high training accuracy across multiple baseline approaches can suggest that the dungeons-hard dataset presents a learnable pattern that various machine learning algorithms can capture when evaluated on the same data used for training.

With continued reference to FIG. 15, the test accuracy results can reveal a substantial performance gap between ORIGAMI and the baseline approaches, highlighting the generalization challenges faced by traditional methods when applied to complex reasoning tasks over semi-structured data. The baseline classifiers including json2vec, LightGBM, XGBoost, Random Forest, and Logistic Regression can exhibit test accuracies ranging approximately between 32% and 41%, substantially below their corresponding training performance levels. The red dashed line at the 0.2 mark can represent the random guessing baseline, indicating that a classifier making random predictions would achieve 20% accuracy given the five possible treasure types in the dataset. In some cases, the baseline methods can demonstrate classic overfitting behavior where high training accuracy fails to translate to comparable test performance, suggesting that these approaches can learn spurious correlations or memorize specific training patterns rather than extracting the underlying logical reasoning rules needed for generalization.

The ORIGAMI architecture can achieve perfect accuracy on both training and test datasets, demonstrating 100% performance across both evaluation metrics as shown in FIG. 15. The consistent performance between training and test phases can indicate that ORIGAMI successfully learns the underlying logical reasoning pattern required to solve the dungeons-hard task rather than memorizing specific training instances or relying on positional cues. The architecture can extract the rule-based relationship between the top-level “door” and “key_color” clues and the corresponding treasure values nested within the corridor array objects. In some cases, the perfect generalization performance can demonstrate the effectiveness of the key/value positional encoding method in maintaining consistent representations for logically equivalent positions across different structural arrangements, enabling the model to apply learned reasoning patterns to novel configurations of the same underlying logical structure.

As further shown in FIG. 15, the performance comparison can highlight the limitations of traditional tabular and JSON processing approaches when applied to tasks requiring multi-step logical reasoning over nested semi-structured data. The baseline methods can struggle with the hierarchical nature of the reasoning task, which can require parsing top-level clues, traversing nested array structures, and extracting target values based on conditional logic. The flattening approach used for tabular classifiers can lose structural information by converting the nested JSON format into sparse tabular representations, potentially disrupting the logical relationships between clues and target values. The json2vec method, while designed to handle JSON data directly, can lack the structural inductive biases needed to maintain consistent representations across different orderings of key/value pairs and array elements, leading to poor generalization when the test data presents the same logical content in different structural arrangements.

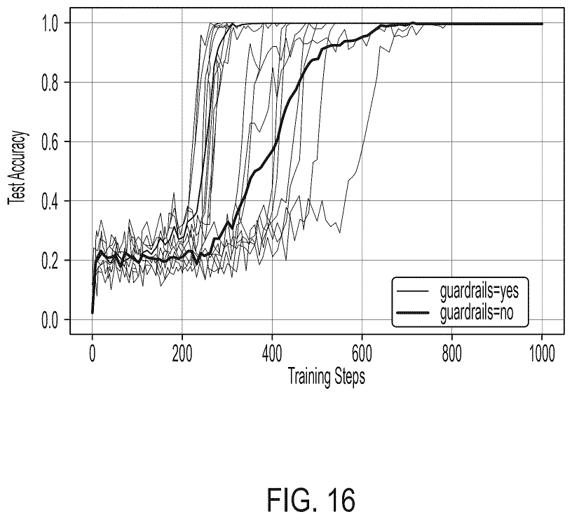

Referring to FIG. 16, the guardrails mechanism can demonstrate substantial improvements in training dynamics and convergence stability when compared to models trained without grammatical constraint enforcement. The experimental comparison can utilize the dungeons-easy dataset to evaluate the impact of grammar-based token masking on model performance, where the easier variant maintains unshuffled corridor arrays that place door objects at positions corresponding to their door numbers. The figure can illustrate accuracy measurements on test data during training progression, with thin lines representing individual training runs and thick lines showing averaged results across multiple random seed initializations. In some cases, the blue lines can represent training with guardrails enabled, while the orange lines can indicate training without the grammatical constraint mechanism, providing a direct comparison of training dynamics under different constraint conditions.

As shown in FIG. 16, models trained with the guardrails mechanism can achieve higher test accuracy levels more rapidly and consistently compared to models trained without grammatical constraints. The blue lines representing guardrails-enabled training can demonstrate faster convergence to optimal performance levels, with the averaged thick blue line showing a smooth progression toward maximum accuracy within the first few hundred training steps. The individual training runs with guardrails can exhibit relatively low variance in convergence timing, suggesting that the grammatical constraint mechanism can provide consistent training benefits across different random initializations. The guardrails approach can enable the model to focus computational resources on learning semantic relationships and logical reasoning patterns rather than expending capacity on grammar rule acquisition, leading to more efficient utilization of the available training data and model parameters.

With continued reference to FIG. 16, the models trained without guardrails can display more variable and slower convergence patterns, as indicated by the orange lines showing greater dispersion in individual run performance. The averaged orange line can demonstrate a more gradual approach to optimal accuracy levels, requiring additional training steps to achieve comparable performance to the guardrails-enabled variants. The increased variance among individual training runs without guardrails can suggest that the absence of grammatical constraints can introduce additional complexity into the learning process, where models can need to simultaneously acquire both grammar rules and semantic reasoning capabilities. In some cases, the variable convergence behavior can indicate that some training runs can struggle to learn the underlying task structure when grammatical validity enforcement is absent, leading to inconsistent performance across different random initializations.

The acceleration of training convergence through grammar-based constraints can result from the elimination of invalid token sequences from the learning objective, allowing the model to concentrate on meaningful data correlations rather than structural validity rules. The guardrails mechanism can suppress logits corresponding to grammatically invalid transitions by setting them to negative infinity before softmax application, effectively removing these options from the model's consideration during both training and inference phases. The constraint enforcement can prevent the model from wasting learning capacity on memorizing JSON grammar rules, which can be deterministically enforced through the pushdown automaton rather than learned through statistical patterns. In some cases, the focused learning approach can enable more efficient gradient updates that directly target the semantic reasoning task, leading to faster convergence and improved stability in the training process.

As further illustrated in FIG. 16, the training stability improvements provided by the guardrails mechanism can manifest through reduced variance in convergence timing and more predictable performance trajectories across different training runs. The grammatical constraint enforcement can eliminate potential failure modes where models might learn invalid token sequences or develop representations that violate structural consistency requirements. The stability enhancement can be particularly valuable in scenarios with limited training data, where the model can benefit from additional inductive biases that guide the learning process toward valid solutions. The guardrails approach can provide a form of structured regularization that maintains the model's focus on task-relevant patterns while preventing exploration of grammatically invalid solution spaces that could lead to training instability or poor generalization performance.

The comparative analysis shown in FIG. 16 can demonstrate that grammar-based constraints serve as an effective mechanism for improving training efficiency in semi-structured data processing tasks. The guardrails system can enable the model to achieve superior performance with fewer training iterations, potentially reducing computational requirements and training time while maintaining or improving final accuracy levels. The constraint mechanism can provide particular benefits in complex reasoning tasks where the model can need to maintain structural consistency while learning logical relationships between nested data elements. In some cases, the guardrails approach can represent a general principle for incorporating domain-specific constraints into neural network training, where explicit enforcement of known structural rules can enhance learning efficiency and model reliability in specialized data processing applications.

### NUMBERED EMBODIMENTS

1. A computer-implemented system for processing semi-structured data, comprising: a tokenizer configured to convert JSON objects into token sequences, wherein the tokenizer treats keys and values as atomic tokens and includes structural tokens to maintain hierarchical relationships; a pushdown automaton configured to generate stack states that capture hierarchical structure of the token sequences and enforce grammatical validity constraints; a key/value position encoder configured to generate position embeddings based on the stack states from the pushdown automaton, wherein the position embeddings are invariant to ordering of key/value pairs at a same hierarchical level; and a transformer-based neural network configured to process the token sequences with the position embeddings to generate probability distributions over a vocabulary for predicting subsequent tokens in the sequences. 2. The system of embodiment 1, wherein the tokenizer includes special grammatical tokens comprising [START] and [END] tokens for demarcating boundaries of top-level JSON objects, [OBJ_START] and [OBJ_END] tokens for nested objects, and Array(length) tokens that encode both presence of an array and its specific length. 3. The system of embodiment 2, wherein the Array(length) tokens enable the system to anticipate a number of subsequent array elements without requiring lookahead mechanisms during token sequence processing. 4. The system of embodiment 1, wherein the pushdown automaton comprises a deterministic pushdown automaton defined as a 6-tuple M=(Q, Σ, F, δ, q_start, F), where Q represents a finite set of states, Σ represents an input alphabet corresponding to a global token vocabulary, Γ represents a finite set of stack symbols, δ represents a transition function, q_start represents a start state, and F represents a set of accepting states. 5. The system of embodiment 4, wherein the pushdown automaton implements a guardrails mechanism that suppresses logits in a model head corresponding to grammatically invalid transitions by setting corresponding logit values to negative infinity before applying a softmax function. 6. The system of embodiment 1, wherein the key/value position encoder calculates position embeddings as a sum of embeddings of stack symbols present at each token position, creating composite position embeddings that encode complete hierarchical context within the JSON structure. 7. The system of embodiment 6, wherein the position embeddings enable sampling of different permutations of key/value pair orderings during training while maintaining consistent positional relationships based on structural hierarchy rather than sequential arrangement. 8. A computer-implemented method for training a neural network on semi-structured data, comprising: tokenizing JSON objects into token sequences using atomic tokens for keys and values and structural tokens for hierarchical relationships; generating stack states using a pushdown automaton that tracks hierarchical structure of the token sequences; computing position embeddings from the stack states, wherein the position embeddings encode hierarchical key paths and array positions while maintaining invariance to key/value pair ordering; sampling different permutations of key/value pairs within the JSON objects to create multiple training instances from each original JSON object; and training a transformer-based neural network using the token sequences with the position embeddings and the permuted training instances to predict next tokens in the sequences. 9. The method of embodiment 8, wherein the structural tokens comprise [START] and [END] tokens for demarcating boundaries of top-level JSON objects, [OBJ_START] and [OBJ_END] tokens for nested objects, and Array(length) tokens that encode both presence of an array and its specific length. 10. The method of embodiment 9, wherein the Array(length) tokens enable anticipation of a number of subsequent array elements without requiring lookahead mechanisms during token sequence processing. 11. The method of embodiment 8, wherein the pushdown automaton implements a guardrails mechanism that suppresses logits corresponding to grammatically invalid transitions by setting corresponding logit values to negative infinity before applying a softmax function during training. 12. The method of embodiment 11, wherein the guardrails mechanism accelerates training convergence by preventing the neural network from learning grammatically invalid token sequences and focusing learning capacity on semantic relationships within the JSON data. 13. The method of embodiment 8, wherein sampling different permutations comprises reordering key/value pairs at a same hierarchical level within the JSON objects while maintaining structural integrity and semantic content of original data. 14. The method of embodiment 13, wherein the permuted training instances provide regularization that prevents the neural network from learning spurious correlations based on specific token orderings rather than semantic content. 15. A computer-implemented system for generating semi-structured data, comprising: a transformer-based neural network trained to generate token sequences representing JSON objects; a pushdown automaton configured to maintain stack states during token generation and constrain token selection to grammatically valid transitions; a positional encoding module configured to generate position embeddings based on hierarchical structure derived from the pushdown automaton stack states; and a token generation module configured to autoregressively generate token sequences by sampling from probability distributions while enforcing grammatical constraints, wherein the system generates valid JSON objects with nested structures and variable-length arrays. 16. The system of embodiment 15, wherein the transformer-based neural network comprises a decoder-only transformer architecture with causal masking to prevent attention to future positions during autoregressive generation. 17. The system of embodiment 16, wherein the decoder-only transformer architecture includes multiple transformer blocks with multi-head self-attention mechanisms and position-wise feed-forward networks incorporating residual connections and layer normalization. 18. The system of embodiment 15, wherein the token generation module generates Array(length) tokens followed by sampling of the specified number of subsequent tokens to complete array structures with variable lengths. 19. The system of embodiment 18, wherein the token generation module generates nested objects by producing sequences of [OBJ_START] tokens, key-value pairs, and [OBJ_END] tokens that represent hierarchical structure of embedded objects. 20. The system of embodiment 15, wherein the pushdown automaton implements a guardrails mechanism that masks invalid token probabilities by setting corresponding logits to negative infinity before sampling during inference to ensure generated sequences represent valid JSON objects.

21. A system comprising: at least one processor operatively connected to a memory, the at least one processor when executing configured to: instantiate a pre-trained transformer model, the transformer model trained on dynamic schema database data and data architecture information, to output a next data element based on an input data element; in response to an input of data elements to the transformer model generate a predictive distribution associated with frequency of occurrence of respective data elements; and define an encoding associated short code words to data elements having the highest predicted frequency of occurrence. 22 A system comprising: at least one processor operatively connected to a memory, the at least one processor when executing configured to: instantiate a pre-trained transformer model, the transformer model trained on dynamic schema database data and data architecture information, to output a next data element based on an input data element; in response to an input of data elements taken from a query under execution to the transformer model generate a predictive distribution associated with frequency of occurrence of respective output data elements associated with execution of the query; and define an encoding associated short code words to data elements having the highest predicted frequency of occurrence.

23. A system comprising: at least one processor operatively connected to a memory, the at least one processor when executing configured to: instantiate a pre-trained transformer model, the transformer model trained on dynamic schema database data and data architecture information, to output a next data element based on an input data element; and in response to an input of data elements taken from a source database including dynamic schema database data generate an output of new dynamic schema database data having a valid format and architecture consistent with the source database. 24. A system comprising: at least one processor operatively connected to a memory, the at least one processor when executing configured to: instantiate a pre-trained transformer model, the transformer model trained on dynamic schema database data and data architecture information, to output a next data element based on an input data element; and in response to an input of data elements including dynamic schema database data generate a cardinality estimate of for queries without having to execute the queries on the source dataset. 25. The system of embodiment 24, wherein the at least one processor is configured to: generate predictive documents unconditionally; and evaluate generated probabilities of a next token following a runtime key input. 26. The system of embodiment 24, wherein the at least one processor is configured to add up the probabilities that match a predicate input. 27. The system of embodiment 26, where the transformer model is configured to generate an output specific to previously generated tokens.

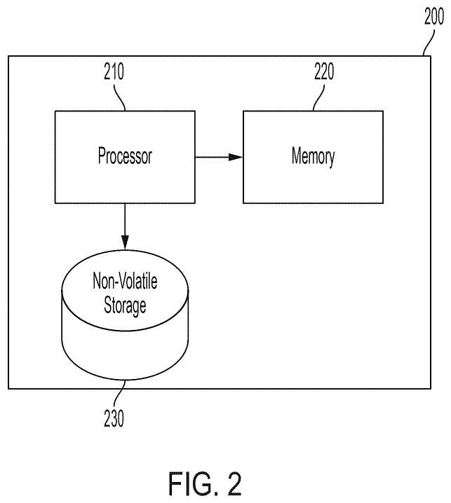

A number of implementations have been described. Nevertheless, it will be understood that various modifications can be made without departing from the spirit and scope of the disclosure. Accordingly, other implementations are within the scope of the following claims. Additionally, an illustrative implementation of a special purpose computer system 200, that can be specially programmed to improve over conventional systems, to be used in connection with any of the examples and/or embodiments provided herein is shown in FIG. 2. The computer system 200 can include one or more processors 210 and one or more articles of manufacture that comprise non-transitory computer-readable storage media (e.g., memory 220 and one or more non-volatile storage media 220). The processor 210 can control writing data to and reading data from the memory 220 and the non-volatile storage device 220 in any suitable manner. To perform any of the functionality described herein (e.g., secure execution, proxied execution, sandboxed execution, etc.), the processor 210 can execute one or more processor-executable instructions stored in one or more non-transitory computer-readable storage media (e.g., the memory 220), which can serve as non-transitory computer-readable storage media storing processor-executable instructions for execution by the processor 210.

The terms “program” or “software” or “app” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods, operations, and/or functions described herein need not reside on a single computer or processor, but can be distributed in a modular fashion among different computers or processors to implement various aspects described herein.

Processor-executable instructions can be in many forms, such as program modules, executed by one or more computers or other devices. Generally, program modules include routines, programs, objects, components, data structures, etc. that perform particular tasks or implement particular abstract data types. Typically, the functionality of the program modules can be combined or distributed as desired in various embodiments.

Also, data structures can be stored in one or more non-transitory computer-readable storage media in any suitable form. For simplicity of illustration, data structures can be shown to have fields that are related through location in the data structure. Such relationships can likewise be achieved by assigning storage for the fields with locations in a non-transitory computer-readable medium that convey relationships between the fields. However, any suitable mechanism can be used to establish relationships among information in fields of a data structure, including through the use of pointers, tags or other mechanisms that establish relationships among data elements.

Also, various inventive concepts can be embodied as one or more processes, of which examples have been provided. The acts performed as part of each process can be ordered in any suitable way. Accordingly, embodiments can be constructed in which acts are performed in an order different than illustrated, which can include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having the same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed:

1. A system for integrating transformer architecture, the system comprising:
at least one processor operatively connected to a memory, the at least one processor configured to:
tokenize dynamic schema database data, the tokenization including positional information associated with the source data;
train a transformer model on the tokenized dynamic schema database data and the positional information as an input;
the transformer model configured to generate predictive distributions corresponding to key value pairs and a valid format for dynamic schema database data; and
output key value pairs associated with the prediction of the valid format.

2. The system of claim 1, wherein the tokenization includes operations to maintain data architecture information associated with the source data.

3. The system of claim 1, wherein the tokenization includes operations to preserve key and value information stored in a source document without reduction to sub-words.

4. The system of claim 1, wherein at least one processor is configured to instantiate a pre-trained transformer model, the pre-trained transformer model trained on dynamic schema database data and data architecture information, to output a next data element based on an input data element.

5. The system of claim 4, wherein the at least one processor is configured to:
generate a predictive distribution associated with frequency of occurrence of respective data elements in response to an input of data elements to the pre-trained transformer model; and
define an encoding of associated short code words to data elements based on predicted frequency of occurrence.

6. The system of claim 4, wherein the at least one processor is configured to:
generate a predictive distribution associated with frequency of occurrence of respective output data elements associated with execution of the query in response to an input of data elements taken from a query under execution to the pre-trained transformer model; and
define an encoding of associated short code words to data elements based on predicted frequency of occurrence.

7. The system of claim 4, wherein the at least one processor is configured to:
generate an output of new dynamic schema database data having a valid format and architecture consistent with the source database in response to an input of data elements taken from a source database including dynamic schema database data.

8. The system of claim 4, wherein the at least one processor is configured to:
generate a cardinality estimate for queries without having to execute the queries on the source dataset in response to an input of data elements including dynamic schema database data.

9. The system of claim 8, wherein the at least one processor is configured to:
generate predictive documents unconditionally; and
evaluate generated probabilities of a next token following a runtime key input.

10. The system of claim 9, wherein the at least one processor is configured to analyze the probabilities that match a predicate input.

11. The system of claim 10, wherein the pre-trained transformer model is configured to generate an output specific to previously generated tokens.

12. A computer-implemented method for integrating transformer architecture, the method comprising:
tokenizing, by at least one processor, dynamic schema database data, the tokenization including positional information associated with the source data;
training, by the at least one processor, a transformer model on the tokenized dynamic schema database data and the positional information as an input;
predicting, using the transformer model, distributions corresponding to key value pairs and a valid format for dynamic schema database data; and
producing key value pairs associated with the prediction of the valid format.

13. The method of claim 12, wherein tokenizing includes maintaining data architecture information associated with the source data.

14. The method of claim 12, wherein tokenizing includes preserving key and value information stored in a source document without reduction to sub-words.

15. The method of claim 12, wherein the method comprises instantiating a pre-trained transformer model, the pre-trained transformer model trained on dynamic schema database data and data architecture information, to output a next data element based on an input data element.

16. The method of claim 15, wherein the method comprises:
generating a predictive distribution associated with frequency of occurrence of respective data elements in response to an input of data elements to the pre-trained transformer model; and
defining an encoding of associated short code words to data elements based on predicted frequency of occurrence.

17. The method of claim 15, wherein the method comprises:
generating a predictive distribution associated with frequency of occurrence of respective output data elements associated with execution of the query in response to an input of data elements taken from a query under execution to the pre-trained transformer model; and
defining an encoding of associated short code words to data elements based on predicted frequency of occurrence.

18. The method of claim 15, wherein the method comprises:
generating an output of new dynamic schema database data having a valid format and architecture consistent with the source database in response to an input of data elements taken from a source database including dynamic schema database data.

19. The method of claim 15, wherein the method comprises:
generating a cardinality estimate for queries without having to execute the queries on the source dataset in response to an input of data elements including dynamic schema database data.

20. The method of claim 19, wherein the method comprises:
generating predictive documents unconditionally; and
evaluating generated probabilities of a next token following a runtime key input.
